(19) United States
(12) Patent Application Publication
(10) Pub. No.: US 2026/0290380 A1
(43) Pub. Date: Sep. 24, 2026

(54) SYSTEM

(71) Applicant: SoftBank Group Corp., Tokyo (JP)

(72) Inventor: Akiyuki HAYASHI, Tokyo (JP)

(73) Assignee: SoftBank Group Corp., Tokyo (JP)

(21) Appl. No.: 19/568,802

(22) Filed: Mar. 17, 2026

(30) Foreign Application Priority Data
Mar. 19, 2025 (JP) 2025-045108

(51) Int. Cl. G10L 25/63; G06N 3/0475

(52) U.S. Cl. CPC G10L 25/63; G06N 3/0475

(57) ABSTRACT

A system includes a processor that is configured to extract, from a database, data related to past business performance and customer traffic for a corresponding past period and analyze the extracted data using a statistical analysis technique, generate a prompt for instructing a generative artificial intelligence model to generate advice, input the prompt into the generative artificial intelligence model, and obtain advice generated by the generative artificial intelligence model, and perform preprocessing on data using an information processing device, normalize the data, and perform feature extraction on the data so as to apply a machine learning algorithm and construct a prediction model.

### CROSS-REFERENCE TO RELATED APPLICATION

This application is based on and claims priority under 35 USC 119 from Japanese Patent Application No. 2025-045108 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional business analysis and forecasting systems often rely on simple aggregation and fixed statistical models that are not able to flexibly incorporate heterogeneous data such as past business performance, customer traffic trends, and contextual information for corresponding past periods. As a result, generated forecasts and business suggestions may lack accuracy and contextual relevance. Furthermore, although generative artificial intelligence models have the capability to generate rich advice, predictions, and proposals, existing systems do not provide an integrated mechanism that systematically prepares appropriate prompts, supplies them to a generative artificial intelligence model, and combines the generated advice with structured prediction models built from preprocessed and normalized data. In addition, many systems do not provide a seamless interface for presenting prediction results and proposals to a user via a user terminal and for collecting user feedback in a manner that allows continuous improvement of the analytical process. Accordingly, there is a need for a system that can: (i) extract and statistically analyze relevant historical data for a corresponding past period; (ii) construct prediction models by applying machine learning algorithms to appropriately preprocessed data; (iii) utilize a generative artificial intelligence model through prompt generation to produce advice, predictions, and proposals; and (iv) present such results to a user and receive feedback via a user terminal.

### SUMMARY

In order to solve the above-described problems, an embodiment of the present invention provides a system comprising a processor, wherein the processor is configured to extract, from a database, data related to past business performance and customer traffic for a corresponding past period and analyze the extracted data using a statistical analysis technique. The processor is further configured to generate a prompt for instructing a generative artificial intelligence model to generate advice, input the prompt into the generative artificial intelligence model, and obtain advice generated by the generative artificial intelligence model. In addition, the processor is configured to perform preprocessing on data using an information processing device, normalize the data, and perform feature extraction on the data so as to apply a machine learning algorithm and construct a prediction model. In one embodiment, the processor is configured to generate a prompt for instructing the generative artificial intelligence model to generate a prediction and a proposal, input the prompt into the generative artificial intelligence model, and obtain the prediction and the proposal generated by the generative artificial intelligence model. In another embodiment, the processor is configured to provide an interface for displaying a prediction result and the proposal via a user terminal and for receiving feedback from a user via the user terminal. By integrating statistical analysis, data preprocessing and feature extraction, machine learning based prediction modeling, and prompt-based utilization of a generative artificial intelligence model, the system can generate accurate and context-aware predictions and proposals and can interactively refine business strategies based on user feedback.

The term “processor” refers to any hardware and/or software component, including one or more CPUs, GPUs, microcontrollers, dedicated logic circuits, or combinations thereof, that executes program instructions to perform the functions described in the present specification.

The term “database” refers to any structured data storage system, including relational databases, non-relational databases, data warehouses, or other data repositories, configured to store and provide access to historical and/or current data related to business performance, customer traffic, and associated contextual information.

The term “past business performance” refers to historical data representing business results for a store, facility, or service, including but not limited to sales amounts, transaction counts, revenue, or other quantitative performance indicators recorded for past periods.

The term “customer traffic” refers to information indicating the number, flow, or behavior of customers or visitors during a given period, including but not limited to counts of visitors, entry and exit times, and time-series data of customer presence.

The term “corresponding past period” refers to a historical time interval selected in relation to a target period to be analyzed or forecast, such as the same month in previous years, the same day of the week in past weeks, or any period designated for comparison with the target period.

The term “statistical analysis technique” refers to any method based on statistics for analyzing data, including but not limited to regression analysis, time-series analysis, hypothesis testing, clustering, correlation analysis, and descriptive statistical calculations. The term “generative artificial intelligence model” refers to an artificial intelligence model configured to generate output data, such as text, numerical values, or structured information, in response to input data, and includes, for example, large language models, generative neural networks, and similar models capable of content generation.

The term “prompt” refers to information, including text, parameters, and contextual data, that is provided as input to a generative artificial intelligence model for the purpose of instructing the model regarding a requested task, such as generating advice, predictions, or proposals. The term “advice” refers to information generated by the system, including recommendations, suggestions, or guidance related to business operations, event planning, budget allocation, or other decision-making aspects, based on analysis, prediction, or outputs of a generative artificial intelligence model.

The term “information processing device” refers to any computing apparatus or component configured to execute data processing operations, including but not limited to servers, client terminals, edge devices, and dedicated hardware that perform preprocessing, normalization, or feature extraction.

The term “preprocessing” refers to operations applied to raw data prior to analysis or model training, including but not limited to data cleaning, missing value handling, transformation, aggregation, and formatting, to prepare the data for subsequent processing.

The term “normalization” refers to a type of preprocessing in which numerical data values are scaled or transformed into a standardized range or distribution, such as by min-max scaling or z-score normalization, in order to facilitate stable and effective application of machine learning algorithms.

The term “feature extraction” refers to a process of generating, selecting, or transforming variables from raw data into a set of explanatory variables, called features, that are suitable for use as inputs to a machine learning algorithm.

The term “machine learning algorithm” refers to any algorithm or model that automatically learns patterns or relationships from data to perform tasks such as prediction, classification, or clustering, including but not limited to regression models, decision trees, random forests, gradient boosting methods, neural networks, and support vector machines.

The term “prediction model” refers to a model constructed by applying a machine learning algorithm to training data and configured to output predicted values, such as future sales amounts or customer traffic, in response to input features derived from historical or contextual data.

The term “prediction” refers to an output generated by a prediction model or a generative artificial intelligence model that estimates or forecasts a future value, state, or event, such as expected sales, expected customer count, or expected performance indicator for a specified period.

The term “proposal” refers to a suggested plan or course of action generated by the system, including but not limited to proposed event schedules, budget distributions, staffing plans, or promotional strategies, based on analysis results, predictions, and generative artificial intelligence outputs.

The term “user terminal” refers to any device operated by a user to access the system, including but not limited to personal computers, tablet devices, smartphones, point-of-sale terminals, or other display and input devices connected to the system via a network. The term “interface” refers to a software and/or hardware component that provides interaction between the system and a user, including graphical user interfaces, web pages, application screens, or APIs that display prediction results and proposals and receive input or feedback from the user.

The term “feedback” refers to information provided by a user in response to prediction results, proposals, or advice presented by the system, including but not limited to evaluations, corrections, confirmations, modifications of plans, and additional constraints or preferences.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

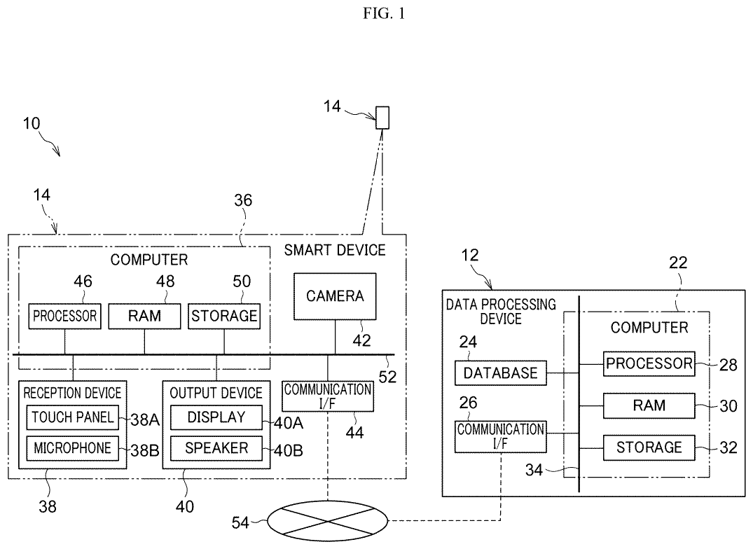

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

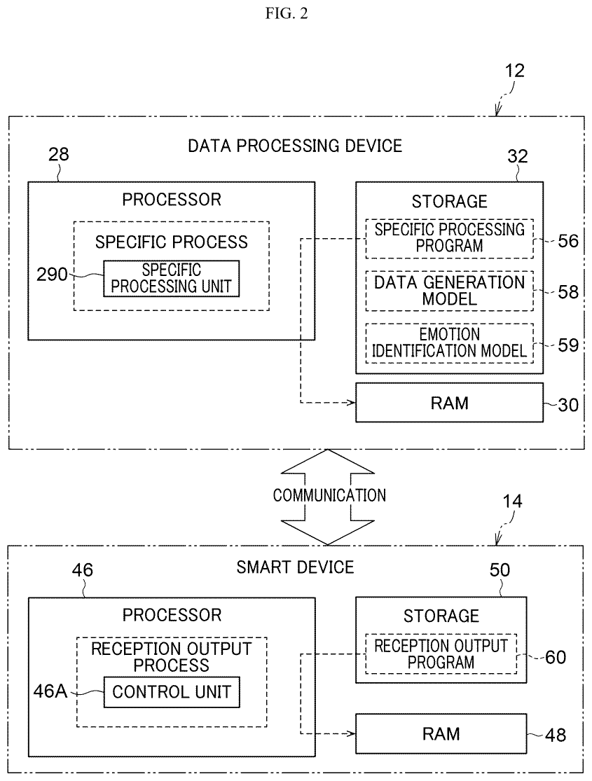

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented sales support systems typically treat time-series business information, visitor information, and event information in a fragmented manner. Statistical analysis modules, predictive models, and user-facing recommendation tools are often implemented as separate components without a unified interaction flow. As a result, several technical problems arise in the operation of data processing systems. First, a processor in a conventional system must perform repeated, ad hoc data transformations each time a prediction or recommendation is requested. Because there is no integrated mechanism to maintain consistency between training data preprocessing and inference-time preprocessing, feature definitions frequently drift over time. This drift degrades the accuracy and stability of prediction models, leading to increased computation for recalibration and manual intervention. Consequently, the underlying computer resources are used inefficiently, and the system cannot reliably support continuous, automated decision-making.

Second, conventional systems typically output prediction results and rule-based suggestions as static data to a user interface, without any structured mechanism to feed these machine-generated outputs into natural language generation modules in a reproducible way. When a separate natural language generation engine or a generative artificial intelligence model is used, the processor must manually assemble unstructured textual prompts each time. This manual, one-off prompt construction often discards machine-readable structure, such as relationships between predicted indicators, event dates, and cost allocations. The loss of structure limits the generative model's ability to generate contextually accurate explanations and proposals, and forces the processor to perform additional formatting and error handling. Third, conventional user interfaces provide only one-way display of prediction results and recommendations. User feedback, such as acceptance, modification, or rejection of proposed plans, is not systematically captured in a form that can be re-used by the underlying prediction models or prompt generation logic. This lack of a closed-loop feedback mechanism prevents the data processing system from continuously improving its internal models or adjusting its prompt construction policies based on real operation data. As a result, the system cannot effectively adapt to changing business conditions or user preferences, and system performance deteriorates over time unless engineers manually reconfigure and retrain the system.

Fourth, when a generative artificial intelligence model is introduced as an additional component, conventional architectures treat it as an external, loosely coupled service. There is no standardized way for the processor to combine structured prediction outputs with user-provided natural language queries to generate a consistent, machine-tractable prompt. This leads to duplicated processing, inconsistent data usage, and an increased number of network round-trips and parsing operations. As a consequence, system latency increases, error handling becomes complex, and the scalability of the overall system is impaired. Accordingly, there is a need for a computer-implemented technique that integrates (i) preprocessing of time-series business and visitor data into consistent explanatory variables, (ii) training and execution of prediction models that output future business indicators and visitor indicators, (iii) generation of structured business measure plans based on those indicators, and (iv) generation and refinement of prompt sentences for a generative artificial intelligence model, together with a mechanism to capture user interaction as feedback. Such a technique should improve the efficiency, reliability, and adaptability of the data processing performed by the processor and should technically enhance the way computer resources are used to generate, explain, and refine predictions and recommendations in a sales support environment.

The specific processing by the specific processing unit 290 of the data processing device 12 in Example 1 is realized by the following means.

The present invention provides a server comprising a processor configured to acquire business information and visitor information from an external information processing apparatus via a communication unit and to store the business information and the visitor information in a relational data storage unit; to obtain, from the relational data storage unit, the business information, the visitor information, event information, and environment information, to perform preprocessing including missing-value completion processing, outlier processing, attribute transformation processing, and derived-attribute generation processing, and to construct explanatory variables for machine learning processing; to generate a prediction model that outputs future business indicators and future visitor indicators by performing learning processing based on the explanatory variables and at least one of the business information and the visitor information, and to calculate the future business indicators and the future visitor indicators by inputting new explanatory variables into the prediction model; to calculate a business measure plan including an event implementation date and a cost allocation based on the future business indicators and the future visitor indicators, and to generate structured information representing the business measure plan; to generate a prompt sentence including explanation information that includes summarized numerical information and condition information of the structured information and including a natural language instruction relating to a business measure, and to cause a generative artificial intelligence model to generate natural language advice relating to the business measure plan by inputting the prompt sentence into the generative artificial intelligence model; to transmit the natural language advice and the business measure plan to a user apparatus and to cause a display interface to display the natural language advice and the business measure plan; to receive, from the user apparatus, a user prompt sentence and user selection information or correction information relating to the business measure plan, to generate a generative-artificial-intelligence-model prompt sentence by combining the user prompt sentence with the structured information, and to cause the generative artificial intelligence model to generate additional natural language advice by inputting the generative-artificial-intelligence-model prompt sentence into the generative artificial intelligence model; and to record the user selection information or the correction information and at least one of the future business indicators and the future visitor indicators, and to perform at least one of a relearning process of the prediction model and an update process of generation conditions of the prompt sentence based on the record. This enables the server to maintain consistent preprocessing and feature construction between training and inference, to automatically derive structured business measure plans from prediction outputs, to systematically transform structured prediction and plan information into prompt sentences for a generative artificial intelligence model, and to incorporate user interaction and feedback into both prediction model relearning and prompt generation policy updates, thereby improving the technical performance, efficiency, adaptability, and scalability of the computer-implemented sales support system.

The term “business information” refers to time-series data representing activity of a commercial entity, including at least transaction amounts, sales quantities, and other numerical indicators of business performance associated with a location and a date or time. The term “visitor information” refers to time-series data representing presence or flow of customers or users, including at least counts of visitors or customers associated with a location and a date or time.

The term “event information” refers to data representing planned or executed events related to business activity, including at least identifiers of events, event types, event implementation dates, and event attributes such as promotion type or target group.

The term “environment information” refers to data representing external conditions that may affect business activity or visitor behavior, including at least weather conditions, calendar attributes such as holidays or weekdays, and other contextual factors associated with a location and a date or time.

The term “external information processing apparatus” refers to a computing apparatus distinct from the server, including at least a business management system, a data supply system, or a sensor system, which provides business information, visitor information, event information, or environment information to the server via a communication network.

The term “communication unit” refers to a hardware and software component of the server that executes data transmission and reception over a communication network using a communication protocol, including at least wired or wireless network interfaces, transport protocols, and application-level interfaces.

The term “relational data storage unit” refers to a data storage apparatus and a management mechanism that store and manage data in a tabular relational format, including at least a storage medium, a relational data management program, and data structures defined by tables, records, and fields.

The term “preprocessing” refers to a sequence of data transformation operations applied to raw data before machine learning or statistical analysis, including at least missing-value completion processing, outlier processing, attribute transformation processing, and derived-attribute generation processing.

The term “missing-value completion processing” refers to a data transformation operation in which records having undefined or absent values in at least one attribute are supplemented by estimated or substituted values generated according to a predetermined rule.

The term “outlier processing” refers to a data transformation operation in which values that deviate from a predetermined statistical range in at least one attribute are removed, corrected, or limited according to a predetermined rule.

The term “attribute transformation processing” refers to a data transformation operation in which original attributes are converted into different representations, including at least normalization, scaling, encoding of categorical values, and conversion of date and time values into derived calendar attributes.

The term “derived-attribute generation processing” refers to a data transformation operation in which new attributes are generated from existing attributes according to predetermined functions, including at least moving averages, lagged values, aggregate values, and binary indicators.

The term “explanatory variables” refers to a set of processed attributes obtained by preprocessing, which are used as input variables to a prediction model in machine learning processing.

The term “learning processing” refers to a computation procedure in which a prediction model is parameterized using training data including explanatory variables and at least one target variable, such that a correspondence between the explanatory variables and the target variable is estimated.

The term “prediction model” refers to a mathematical or computational model trained by learning processing, which receives explanatory variables as input and outputs at least one predicted value, including at least future business indicators and future visitor indicators.

The term “future business indicators” refers to predicted values output by the prediction model that represent expected business performance at future points in time, including at least predicted sales amounts, predicted transaction counts, and other numerical measures.

The term “future visitor indicators” refers to predicted values output by the prediction model that represent expected visitor flow at future points in time, including at least predicted visitor counts and other numerical measures of visitor behavior.

The term “business measure plan” refers to structured plan information generated based on future business indicators and future visitor indicators, including at least one event implementation date, one cost allocation, and additional parameters describing proposed business measures.

The term “event implementation date” refers to a date or date and time at which an event related to a business measure is proposed to be executed, as determined by the processor based on prediction results.

The term “cost allocation” refers to an assignment of a total available cost or budget to one or more elements of a business measure plan, including at least allocation to each event implementation date or each campaign period.

The term “structured information” refers to data representing a business measure plan and associated indicators in a machine-readable format, including at least identifiers, attributes, and numerical values arranged according to a predefined schema.

The term “prompt sentence” refers to a sequence of characters including natural language instructions and optionally structured or summarized numerical and condition information, which is generated by the processor and provided as input to a generative artificial intelligence model.

The term “generative artificial intelligence model” refers to a trained computational model that receives a prompt sentence as input and outputs natural language text, including at least explanations, proposals, or advice generated based on the prompt sentence.

The term “natural language advice” refers to textual output generated by the generative artificial intelligence model in a human language, describing or recommending at least one business measure based on structured information and a prompt sentence.

The term “user apparatus” refers to a computing apparatus operated by a user, including at least a terminal device, a client device, or a display device, that communicates with the server, displays information, and transmits user inputs.

The term “display interface” refers to a user interface generated by the user apparatus or the server, which visually presents at least prediction results, business measure plans, and natural language advice, and accepts user operations.

The term “user prompt sentence” refers to a natural language input provided by a user via the display interface, which expresses at least a question, a request, or a condition relating to prediction, explanation, or a business measure.

The term “selection information” refers to information indicating that a user has accepted, rejected, or chosen among one or more business measure plans, as input via the display interface.

The term “correction information” refers to information indicating that a user has modified part of a business measure plan, including at least changes to event implementation dates, cost allocations, or other plan parameters.

The term “generative-artificial-intelligence-model prompt sentence” refers to a prompt sentence generated by combining at least a user prompt sentence and structured information, which is provided as input to the generative artificial intelligence model to obtain additional natural language advice.

The term “record” refers to stored information that associates at least one of selection information or correction information with at least one of future business indicators or future visitor indicators, in a storage unit accessible to the processor.

The term “relearning process of the prediction model” refers to a process in which the prediction model is retrained or updated using training data that include recorded information, such that model parameters are modified based on user interaction and updated data.

The term “update process of generation conditions of the prompt sentence” refers to a process in which rules, templates, or parameters used to generate prompt sentences are changed based on recorded information, such that subsequent prompt sentences are constructed according to updated conditions.

The server executes a computer program that integrates data acquisition, preprocessing, prediction, recommendation, and generative AI interaction on a networked computing platform. The server is implemented as an electronic computer system including at least one central processing unit, a main memory, a non-volatile storage device, a network interface, and a display interface module. The server runs a general-purpose operating system, a relational database management program, and an application program composed of multiple software modules implemented, for example, in a Python runtime environment. The server cooperates with at least one terminal and at least one user apparatus via a communication network.

The server uses concrete hardware and software components to implement each functional block. The server uses a processor based on an instruction set architecture, such as an x86-compatible central processing unit, and optionally a graphics processing unit equipped with a parallel computing framework. The server uses a storage unit composed of a non-volatile memory device, such as a solid-state drive, and a volatile memory device, such as a random access memory module. The server uses a network interface card supporting standard communication protocols, such as Ethernet and Transmission Control Protocol/Internet Protocol. The server executes a relational data management program such as a general-purpose relational database management system, which stores data in tables with defined schemas. The server executes application libraries such as a numerical computation library, a data-frame manipulation library, a machine learning library, and a deep learning library. These libraries correspond, for example, to a matrix operation library, a table-oriented data processing library similar to Pandas, a machine learning toolkit similar to Scikit-learn, and a neural network framework similar to TensorFlow or Keras.

The server stores, in the relational database, business information, visitor information, event information, environment information, prediction results, and recommendation results. The server defines normalized table schemas. For example, the server defines a business information table including columns for a business location identifier, a date, a transaction amount, and a transaction count. The server defines a visitor information table including columns for a business location identifier, a date, and a visitor count. The server defines an event information table including columns for a business location identifier, an event identifier, an event type, an event implementation date, and event attributes. The server defines an environment information table including columns for a location identifier, a date, a weather code, a temperature, a precipitation amount, and calendar attributes such as weekday flags and holiday flags. The server uses a primary key and a foreign key to maintain referential integrity between these tables. This structured storage enables the server to efficiently join and filter data using indexed queries, thereby reducing the number of scan operations and improving access latency.

The server acquires business information and visitor information from at least one external information processing apparatus. The server transmits a request message via the network interface using a standard application protocol. The server receives a response message in a structured data format, such as a comma-separated text or a structured text notation. The server parses the response using a parsing module and converts fields in the response into database rows. The server stores the converted rows into the relational database using a database driver. The server also acquires environment information such as weather and calendar attributes from external data supply systems. The server periodically executes this acquisition in response to a time-based trigger, so that the stored data are incrementally updated without human intervention. This automated acquisition reduces human input errors and ensures consistent and timely data feed to the later prediction and recommendation modules.

The server applies a preprocessing pipeline to the stored data by executing sequential operations on data frames created in memory. The server loads rows from the relational database into data-frame objects using an adapter that converts tabular query results into in-memory column-oriented structures. The server executes missing-value completion processing by scanning each relevant column for null or undefined entries. For numerical attributes such as sales amounts and visitor counts, the server computes a replacement value using a statistical function, such as a mean value over a time window, a median value, or a last-observation-carried-forward rule. The server writes the replacement values into the data-frame cells. For categorical attributes, the server replaces missing values with a designated category or removes rows according to preset rules.

The server executes outlier processing by computing, for each numerical attribute, a distribution statistic such as a mean and a standard deviation, or a quartile and an interquartile range. The server computes a z-score or deviation ratio for each value relative to the distribution. The server compares each z-score or deviation ratio to a configured threshold. For values exceeding the threshold, the server either removes the corresponding row or caps the value at a boundary, such as a percentile value. The server performs these calculations using vectorized operations of the data-frame library, reducing the number of loops and thereby improving processing throughput compared with naive per-record processing. The server executes attribute transformation processing by converting raw attributes into normalized or encoded forms. The server normalizes continuous variables, such as transaction amounts or visitor counts, by subtracting a mean and dividing by a standard deviation, or by applying a min-max scaling procedure. The server encodes categorical variables, such as event types or weather conditions, into numerical vectors using label encoding or one-hot encoding. The server converts date strings into internal timestamp representations and computes derived calendar attributes such as a weekday index, a holiday flag, a month index, and a season identifier. The server then appends these derived attributes as additional columns.

The server executes derived-attribute generation processing to compute features that capture temporal dependencies and trends. The server calculates moving averages of sales or visitor counts over various windows, such as seven days or thirty days, using sliding-window operations implemented in the data-frame library. The server calculates lagged values by shifting the time series and copying past values into new feature columns. The server creates binary features representing whether an event occurs on a date or within a window around an event. The server creates interaction features, such as a product of a weather indicator and a holiday flag. By performing all of these transformations within an integrated pipeline using column-wise operations, the server maintains a consistent feature definition between training and inference, which is a specific technical improvement over systems that rely on separate hand-written scripts for each use case.

The server constructs explanatory variables for machine learning processing from the resulting data frames. The server selects a set of feature columns and a target column representing either a future business indicator or a future visitor indicator. The server converts the feature columns into a multidimensional numerical array. The server may also perform dimensionality reduction or feature selection using algorithms such as variance thresholding or correlation analysis. This structured feature array improves cache efficiency and allows the machine learning library to perform matrix operations optimally, thereby improving processing speed and energy efficiency.

The server trains a prediction model using a machine learning library. In one embodiment, the server uses a gradient-boosted decision tree model that repeatedly fits decision trees to residual errors, yielding high accuracy for tabular data. In another embodiment, the server uses a neural network implemented in a deep learning library. The server defines a multi-layer perceptron with an input layer whose size equals the number of explanatory variables, one or more hidden layers with a specified number of units, and an output layer that produces one or more numerical predictions. The server uses activation functions such as rectified linear units in the hidden layers. The server defines a loss function such as mean squared error for regression tasks. The server applies an optimization algorithm such as stochastic gradient descent or an adaptive moment estimation algorithm to update the network's weights.

The server divides the feature array and target array into training data and validation data according to a predetermined ratio or a time-based split, taking into account the temporal nature of the data. The server iteratively performs forward passes to compute predictions, backward passes to compute gradients of the loss function with respect to the model parameters, and weight updates using the optimization algorithm. The server executes these operations using the linear algebra routines provided by the deep learning library, which may use a graphics processing unit for acceleration. By leveraging the parallel architecture of the graphics processing unit, the server significantly reduces the training time for large data sets compared with a purely central processing unit-based implementation.

The server periodically retrains or fine-tunes the prediction model when new data become available. The server can adopt an incremental learning strategy in which the model parameters are updated using a smaller learning rate and a subset of recent data. In another embodiment, the server trains multiple models specialized for different locations or event types and selects an appropriate model according to the context at inference time. These alternative embodiments show that the invention is not limited to a single model architecture and that the server can flexibly adapt the training method to different deployment conditions. The server generates future business indicators and future visitor indicators by applying the trained prediction model to new explanatory variables. The server constructs new feature arrays for future dates by combining known or forecasted environment information, planned event information, and historical data windows. The server invokes the prediction function of the model library to compute predicted values for each future date and location. The server writes these prediction results back into the relational database, with fields indicating the model version, prediction timestamp, and error metrics when available. This structured storage of prediction outputs supports later analysis and comparison between different model configurations, thereby improving the manageability of the overall system.

The server generates a business measure plan based on the prediction results. The server executes a rule-based algorithm or an optimization algorithm that takes the predicted indicators as inputs. For example, the server identifies candidate event implementation dates by selecting dates whose predicted visitor count exceeds a threshold or whose predicted sales amount lies within a specified percentile range. The server groups dates into planning periods and assigns a cost allocation to each date according to a rule, such as allocating a fixed total budget proportionally to the predicted uplift in a target metric. The server enforces constraints such as a maximum number of events per week, a minimum budget per event, or blackout periods where events are not allowed. The server outputs a structured business measure plan containing, for each proposed event, an implementation date, a proposed cost share, and associated predicted impacts.

The server generates a prompt sentence for a generative AI model in order to obtain natural language advice regarding the business measure plan. The server constructs the prompt sentence by combining textual templates with actual numerical values and condition information. For example, the server may generate a prompt sentence of the following form: “Based on the following predicted visitor counts and sales for Store A over the next 14 days, and the proposed event dates and budget allocations, explain the recommended strategy in plain language for a store manager. Predicted visitors: [list of dates and predicted visitors]. Proposed events: [list of dates and budgets]. Provide reasons for choosing each date and suggest how staff should prepare.”

In another example, the server generates a prompt sentence based on a user request:
“Predict the number of visitors for next Monday and propose an appropriate event date and budget allocation for my store.”

In yet another example, the server processes a user request of the form:
“Based on the forecasted sales for the next two weeks, suggest the optimal three days to run a discount campaign and explain why.”

The server embeds structured data, such as lists of dates, predicted indicators, event flags, and cost allocations, into the text of the prompt sentence in a consistent and machine-derivable format, such as labeled bullet points or semicolon-delimited records. By maintaining this structured embedding, the server preserves the relationship between each numerical value and its context. This reduces ambiguity and enables the generative AI model to produce more precise and coherent text, while also making the prompt sentences mechanically reproducible.

The server communicates with a generative AI model hosted either on the same server or on an external computational resource. The server sends the prompt sentence to the generative AI model via a programmatic interface. The generative AI model, in one embodiment, is a transformer-based language model with multiple attention layers, which has been pre-trained on a large corpus of text and optionally fine-tuned for explanation and recommendation tasks. The server specifies parameters such as a maximum number of tokens and a randomness control parameter. The generative AI model iteratively computes, for each position in the output sequence, a probability distribution over vocabulary tokens based on attention mechanisms that consider both the prompt sentence and previously generated tokens. The model then selects tokens according to the probability distribution and the specified randomness control parameter until an end-of-sequence condition is reached. The generated tokens form the natural language advice.

The server receives the generated text from the generative AI model and may perform post-processing. The server can filter out prohibited phrases, adjust formatting, or split long responses into sections. The server attaches metadata, such as model identifier, generation timestamp, and prompt version, to the stored advice. Because the server uses a fixed template and data binding to generate prompt sentences, the content and structure of the prompts are consistent across requests, which simplifies error detection and allows for systematic tuning of prompt composition rules to improve answer quality.

The terminal operates as a user apparatus that allows a user to view the prediction results, the business measure plans, and the generated natural language advice. The terminal is implemented as a handheld device, a tablet, or a personal computer that includes a display, an input device, a communication unit, and a local processor. The terminal executes a client application, such as a web browser or a dedicated user interface application developed using a graphical user interface framework. The terminal sends a request to the server, receives a structured response in a machine-readable format, and converts the response into visual elements such as charts, tables, and text views.

The terminal displays time-series graphs of future business indicators and future visitor indicators, alongside tabular schedules of event implementation dates and cost allocations. The terminal also displays the natural language advice from the generative AI model in a dialogue-style panel. The terminal provides input elements, such as text fields and buttons, for the user to enter user prompt sentences and to select or modify elements of the business measure plan. For example, the user may click on a proposed event date to adjust the budget, or type an additional prompt sentence such as:
“Show me a lower-budget plan with similar expected results.”

The terminal packages these user inputs and transmits them back to the server via the communication network.

The user operates the terminal to iteratively refine the recommendations. The user can accept or reject proposed events, shift dates, or adjust costs. The user can also request explanations of alternative scenarios via user prompt sentences. The user's interactions are thus captured as digital signals that the server uses in subsequent processing.

The server receives user prompt sentences, selection information, and correction information from the terminal and stores them along with associated prediction and plan data. The server generates a new generative-AI-model prompt sentence by combining the user's natural language input with the structured business measure plan and the associated indicators. For example, the server may generate a composite prompt sentence of the following form:
“The user has requested a lower-budget plan with similar expected results. The current predicted visitors and sales for the next 14 days, and the current business measure plan, are as follows: [structured list]. Propose a revised plan with reduced total cost, and explain the trade-offs.”

The server then sends this composite prompt sentence to the generative AI model and obtains additional natural language advice, which it returns to the terminal. This loop enables interactive refinement while maintaining a machine-tractable link between the user's natural language requests and the underlying numerical data.

The server leverages the recorded selection information and correction information to update both the prediction model and the prompt generation rules. For example, if users consistently reject events on certain days or under specific conditions, the server can adjust the rule-based component of the business measure plan generation, such as lowering the priority of such days or excluding certain patterns. Additionally, the server can use the accepted and rejected plans, along with the realized business outcomes, as labeled data to retrain the prediction model or to develop a secondary model that predicts user acceptance likelihood. The server can modify hyperparameters, loss functions, or feature sets based on this feedback. The server can also adjust prompt templates by, for example, adding more explicit enumeration of constraints or clarifying how uncertainties are to be described.

From a technical perspective, this integrated architecture improves computer technology in several ways. First, the server's unified preprocessing pipeline ensures that feature engineering at training time and feature engineering at inference time are identical. This eliminates feature drift that often requires manual corrections and repeated runs, thereby reducing redundant computations and decreasing processor load. Second, the explicit design of data structures (normalized relational tables and column-oriented data frames) and the use of vectorized operations significantly reduce memory fragmentation and increase cache locality, resulting in faster and more energy-efficient computation compared with row-wise or ad hoc data handling.

Third, the structured embedding of prediction results and business measure plans into prompt sentences improves the effective bandwidth of information transmitted to the generative AI model. By encoding numerical and categorical data in a deterministic and labeled format within the natural language text, the server enables the generative AI model to consistently interpret the context without requiring separate, redundant explanation text. This reduces the size of the prompt while preserving informational richness, which in turn reduces network communication load, cuts latency, and allows the generative model to focus its computational capacity on generating relevant content.

Fourth, the feedback-driven retraining and prompt adaptation processes transform the system from a static automation of human tasks into a continuously improving computational apparatus. The server exploits patterns in aggregated user feedback to restructure internal models and prompt generation policies, leading to systematic reductions in prediction error and improvements in recommendation acceptance rates over time. These improvements are the result of algorithmic adjustments in the server's internal components, not merely of changes in business rules, and therefore represent enhancements to the functioning of the computer system itself.

Fifth, the server can be configured with alternative model architectures or rule engines that are not conventionally used in manual decision-making. For instance, the server can use a multi-task neural network that simultaneously predicts multiple future indicators, sharing intermediate representations across tasks. The server can incorporate regularization techniques, such as dropout or weight decay, to improve generalization. The training procedure can include early stopping based on validation loss to prevent overfitting and reduce computational waste. The server can also implement non-standard cost functions that penalize underprediction or overprediction asymmetrically to reflect the technical goal of minimizing particular types of error. These algorithmic patterns are not trivial translations of human heuristics; they exploit the computational capabilities of the hardware to achieve performance levels that cannot be easily replicated without such specialized algorithms. In summary, the server, terminal, and user cooperate in a system in which the server performs concrete data processing and model computation on explicit data structures using specified software components; the terminal displays the resulting information and captures structured user interactions; and the user guides the system through prompt sentences and feedback. The combination of unified preprocessing, structured prediction and plan generation, systematic prompt construction for a generative AI model, and feedback-based model and prompt updating yields tangible improvements in processing speed, prediction accuracy, communication efficiency, and adaptability of the computer system as a whole.

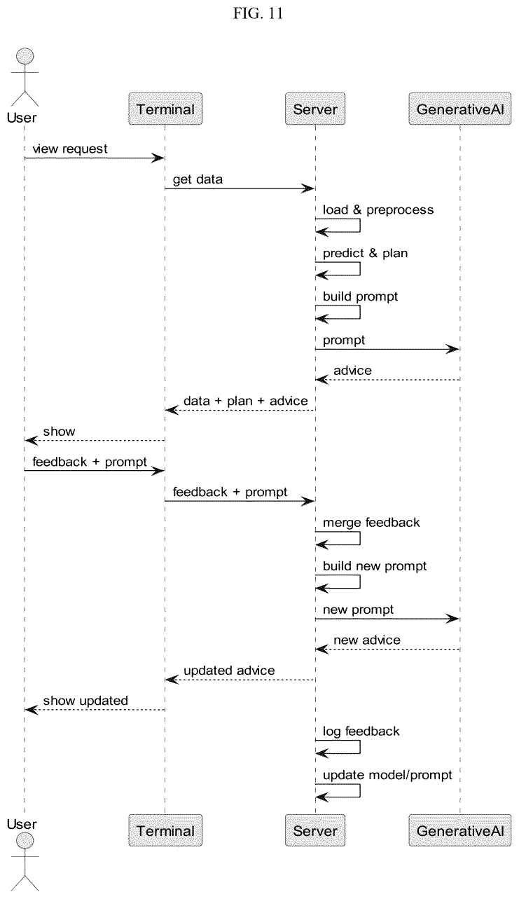

The following describes the processing flow using FIG. 11.

### Step 1:

The server acquires raw data from external systems and stores it in a relational database. The server receives as input external data streams including business information, visitor information, event information, and environment information from at least one external information processing apparatus via a communication network. The server parses response payloads formatted as structured text into internal records, converts data types (for example, string to numeric or datetime), and maps each field to predefined columns of normalized tables. The server then executes insert or update operations through a database driver to store the converted records into a relational data storage unit, producing as output a set of populated relational tables that are indexed by location identifiers and dates.

### Step 2:

The server retrieves stored data and constructs in-memory data frames as a basis for preprocessing.

The server receives as input query parameters such as a target time period, a set of business locations, and required data categories. The server generates structured query statements that join and filter the business, visitor, event, and environment tables according to the input parameters. The server executes these queries via the database driver and converts the query results into column-oriented data frames in main memory. The server outputs one or more data-frame objects that contain synchronized rows keyed by location and date, which are used as inputs for subsequent preprocessing.

### Step 3:

The server performs missing-value completion processing on the data frames.

The server receives as input the raw data-frame objects produced in Step 2. The server scans each column to detect null or undefined values, and for each detected missing value the server computes a replacement value using statistical functions such as mean, median, or last-known observation within a specified temporal window. The server then writes the computed replacement value into the corresponding cell of the data frame. The server outputs a modified data frame in which missing entries are replaced by calculated values, thereby producing a complete dataset for further analysis.

### Step 4:

The server performs outlier processing to remove or cap anomalous values.

The server receives as input the completed data frame from Step 3. The server calculates distribution statistics for numerical attributes (for example, mean and standard deviation or quartiles and interquartile range) across a defined grouping such as per location or per time segment. The server computes a deviation metric such as a z-score for each value and compares this metric with a configured threshold. For values exceeding the threshold, the server either removes the corresponding records or replaces the values with boundary values derived from quantiles. The server outputs a cleansed data frame in which extreme anomalies are mitigated, reducing distortion in subsequent model training.

### Step 5:

The server performs attribute transformation processing and derived-attribute generation to construct explanatory variables.

The server receives as input the cleansed data frame from Step 4. The server normalizes continuous attributes by applying scaling formulas (for example, min-max scaling or standardization) and encodes categorical attributes, such as event type or weather category, into numerical vectors using encoding rules. The server converts date strings into internal timestamp representations and derives calendar attributes including weekday indices, holiday flags, and seasonal identifiers. The server generates additional attributes such as moving averages, lagged values, and interaction terms by applying sliding-window operations and algebraic combinations. The server outputs a feature-enriched data frame whose columns constitute explanatory variables suitable for machine learning.

### Step 6:

The server divides the data into training and validation sets and trains a prediction model. The server receives as input the feature-enriched data frame from Step 5 and a specification of target variables indicating future business indicators or future visitor indicators. The server splits the data frame into an input tensor of explanatory variables and an output vector of target values, and then partitions these tensors into a training set and a validation set according to a defined strategy such as time-based splitting or random sampling. The server selects a machine learning algorithm, for example a gradient-boosted tree model or a multi-layer neural network, initializes its parameters, and iteratively updates the parameters by minimizing a loss function such as mean squared error using an optimization algorithm. The server outputs a trained prediction model and associated evaluation metrics, such as validation error values, stored in memory or persistent storage.

### Step 7:

The server generates future predictions using the trained model.

The server receives as input the trained prediction model from Step 6 and new explanatory variables for future time periods constructed from updated environment information and planned events. The server formats the new explanatory variables into an input tensor with the same structure as used during training, and then invokes the model's prediction function to compute predicted values. The server outputs numerical predictions of future business indicators and future visitor indicators for each specified location and future date, and records these predictions into a prediction table in the relational database.

### Step 8:

The server computes a business measure plan based on the prediction results.

The server receives as input the prediction records from Step 7 and configuration parameters such as budget constraints and event frequency limits. The server applies rule-based logic or an optimization routine that ranks candidate dates according to predicted indicators, selects a subset of dates that satisfy constraints, and assigns cost allocations proportional to predicted uplift or according to predefined ratios. The server constructs a business measure plan consisting of event implementation dates, cost allocations, and associated predicted outcomes. The server outputs structured plan records that represent the business measure plan in a machine-readable format.

### Step 9:

The server constructs a prompt sentence for a generative AI model by combining structured plan data and numerical summaries.

The server receives as input the structured business measure plan from Step 8, the associated prediction values, and configuration parameters specifying the explanation style and target audience. The server generates textual summaries of numerical indicators and encodes the plan elements into labeled segments, then inserts these summaries into a natural language template that includes explicit instructions for explanation or proposal generation. For example, the server may generate a prompt sentence such as “Predict the number of visitors for next Monday and propose an appropriate event date and budget allocation for my store.” or “Based on the forecasted sales for the next two weeks, suggest the optimal three days to run a discount campaign and explain why.” The server outputs a complete prompt sentence that contains both natural language instructions and embedded structured information.

### Step 10:

The server sends the prompt sentence to a generative AI model and obtains natural language advice.

The server receives as input the prompt sentence from Step 9 and configuration parameters for the generative AI model such as maximum output length and randomness level. The server packages the prompt sentence into a request message to the generative AI model interface, transmits the request via the communication network, and waits for a response. The generative AI model processes the prompt sentence and returns generated text. The server receives this response, validates its structure, and optionally post-processes the text to adjust formatting. The server outputs natural language advice describing or justifying the business measure plan.

### Step 11:

The terminal requests and displays prediction results, business measure plans, and natural language advice to the user.

The terminal receives as input a user request to view recommendations, which may include a selection of a location, a time range, or a scenario. The terminal sends a request message to the server and receives a response containing prediction data, business measure plan data, and natural language advice from Step 10. The terminal parses the response, renders time-series charts, tabular schedules, and text descriptions on the display, and arranges them in a dashboard and dialogue-style interface. The terminal outputs visual representations on the display that are perceivable and operable by the user.

### Step 12:

The user reviews the displayed information and provides feedback and additional prompt sentences.

The user receives as input the visual content presented on the terminal, including predicted indicators, event implementation dates, cost allocations, and textual explanations. The user compares alternative dates, examines expected outcomes, and interacts with interface elements such as selection buttons and text input fields. The user may accept or reject individual events, adjust budgets, or type a user prompt sentence such as “Show me a lower-budget plan with similar expected results” or “What happens if I avoid events on Mondays?” The user outputs selection information, correction information, and user prompt sentences through the terminal interface.

### Step 13:

The terminal transmits user inputs to the server for further processing.

The terminal receives as input the user's selection information, correction information, and user prompt sentences from Step 12. The terminal aggregates these inputs into a structured payload that includes identifiers of the affected events, modified values, and the raw natural language content. The terminal transmits this payload to the server via the communication network. The terminal outputs a set of digital messages that encode the user's feedback and additional requests.

### Step 14:

The server combines user prompt sentences with structured plan information to generate a new prompt sentence for the generative AI model.

The server receives as input the payload from the terminal containing user prompt sentences and updated plan or constraint information. The server retrieves the current structured business measure plan and relevant prediction data from the relational database, and merges them with the user's constraints, such as reduced budget or restricted days. The server then constructs a composite prompt sentence that includes the user's natural language request and a machine-derived summary of the updated plan context. The server outputs a new generative-AI-model prompt sentence that is tailored to the user's feedback.

### Step 15:

The server logs user feedback and updates prediction and prompt generation components. The server receives as input the selection information, correction information, associated prediction results, and, optionally, realized performance data when available. The server writes these items into a feedback table that links user decisions and outcomes with specific model outputs and prompt templates. The server analyzes the feedback distribution to adjust hyperparameters of the prediction model, such as regularization strength or feature selection rules, and to modify template elements in prompt generation, such as the level of detail or ordering of information. The server outputs updated model parameters and updated prompt generation rules, thereby improving the behavior of subsequent executions of Steps 6 through 10.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented advisory systems for business planning typically rely on static rule sets, simple statistical summaries, or manually crafted reports generated from historical business data. Such systems suffer from several technical limitations in the way they process and utilize data on general-purpose computing hardware.

First, these systems generally do not perform systematic, machine-executable preprocessing of heterogeneous data sources, such as business transaction records, user visit logs, and environmental information, in a unified computational pipeline. As a result, missing values, outliers, and inconsistent data formats propagate into subsequent processing stages, causing unstable behavior of prediction algorithms and requiring manual intervention by operators. This leads to suboptimal utilization of processing resources and increased latency in generating useful outputs.

Second, known systems often separate prediction processing and natural language explanation into loosely coupled or manual workflows. Predictive models, when present, typically output numeric values that are not automatically converted into structured advice and human-readable explanations. Consequently, the computing system cannot autonomously transform intermediate numerical results into machine-understandable structured advice data and then into natural language advisory sentences. This fragmentation prevents efficient re-use of computational artifacts and complicates integration with portable information terminals.

Third, traditional advisory systems do not exploit generative AI models in a manner that is tightly integrated with internal machine learning pipelines. In typical implementations, if a generative AI component is used at all, it is invoked with generic, manually written prompts that are not derived programmatically from the system's own prediction results and structured advice. Such ad hoc prompting fails to harness the full capabilities of generative models, leads to inconsistent or non-deterministic advisory output, and does not adapt automatically to changing prediction models or business conditions.

Fourth, existing systems generally lack a closed feedback loop in which user interactions on a portable information terminal directly inform and update the internal generation conditions for advice, prompt construction, and model learning. User feedback, when collected, is often stored only as unstructured comments or is processed offline. This prevents the computing system from programmatically adjusting its structured advice generation logic, prompt generation logic, and learning conditions of its prediction models, and thus prevents continuous technical improvement of the advisory performance and system behavior. From a computer-technology perspective, these limitations result in inefficient use of storage, processing, and communication resources, as the system cannot effectively transform raw data into higher-level structured and natural language outputs in an automated and adaptive pipeline. The absence of a unified mechanism for (i) data acquisition and preprocessing, (ii) model-based prediction, (iii) structured advice generation, (iv) automatic construction of prompt sentences for generative AI models, and (v) feedback-based updating of internal conditions, leads to increased computational overhead, reduced scalability, and reduced robustness of the advisory system when deployed on real-world server hardware and portable information terminals.

Accordingly, there is a need for a computer-implemented technique that improves the technical functioning of an advisory system by integrating data preprocessing, prediction modeling, structured advice generation, automatic prompt sentence construction for a generative AI model, natural language advice generation, and user feedback handling into a cohesive, machine-executable architecture. Such a technique should allow the server to automatically derive consistent prompt sentences and advice texts from internal prediction results and structured advice information, and to update its own internal models and generation conditions based on user feedback, thereby improving the efficiency, reliability, and adaptability of the overall computing system.

The specific processing by the specific processing unit 290 of the data processing device 12 in Application Example 1 is realized by the following means.

The present invention provides a server comprising a processor configured to access an information storage medium storing past business information, user visit information, and environmental information, to acquire the past business information, the user visit information, and the environmental information from the information storage medium by using a structured query mechanism, and to load acquired data sets into a storage area of a general-purpose information processing resource; to perform, on the general-purpose information processing resource, preprocessing on the acquired data sets, the preprocessing including at least one of missing-value completion processing, outlier removal processing, attribute transformation processing, categorical-information numerical conversion processing, and normalization processing, and to generate learning input data and teaching data; to construct a prediction mathematical model by using a machine learning program operating on a general-purpose numerical computation resource based on the learning input data and the teaching data, and to store the constructed prediction mathematical model in a storage device; to execute inference processing by inputting prediction input data, which reflects latest business information, latest user visit information, and future environmental information, into the prediction mathematical model, and to output future business indicators and future user visit indicators; to generate structured advice information including at least one of an action plan candidate and a resource allocation candidate by determining, in accordance with predetermined conditions, a high-demand period and a low-demand period based on the future business indicators and the future user visit indicators obtained by the inference processing; to automatically generate a prompt sentence to be input to a generative information generation model, the prompt sentence being for converting explanation data, including the structured advice information and results of the inference processing, into a natural language expression; to input the automatically generated prompt sentence and the explanation data into the generative information generation model, to cause the generative information generation model to generate an advice sentence in natural language regarding contents of the structured advice information and the future business indicators and the future user visit indicators, and to acquire a generation result; to generate transmission information for transmitting the acquired advice sentence and the results of the inference processing to a portable information terminal via a communication network, and to distribute the transmission information as output data to be presented on the portable information terminal; and to update at least one of generation conditions of the structured advice information, generation conditions of the prompt sentence, and learning conditions of the prediction mathematical model based on evaluation information or selection information received from a user via the portable information terminal. This enables improvement of the technical operation of the advisory system by providing an integrated, computer-implemented pipeline that automatically preprocesses heterogeneous data, constructs and applies a prediction model, derives structured advice information, programmatically generates prompt sentences for a generative AI model based on internal prediction results, produces consistent natural language advisory output, and adaptively refines internal generation and learning conditions using user feedback, thereby enhancing computational efficiency, robustness, and responsiveness of the server and associated portable information terminals.

The term “information storage medium” refers to a non-transitory computer-readable storage apparatus, such as a magnetic storage device, a semiconductor memory, or an optical storage device, that stores digital data including business information, user visit information, and environmental information.

The term “past business information” refers to historical data representing business activities, including at least transaction records, revenue amounts, and other time-stamped operational metrics of a business entity.

The term “user visit information” refers to data indicating the presence, count, or behavior of users or customers at a location or service, including at least visit counts, visit times, and temporal patterns of user arrivals.

The term “environmental information” refers to data representing external conditions that may influence business activity, including at least weather conditions, calendar information, and event schedules.

The term “structured query mechanism” refers to a software-controlled data access technique, such as a query language engine or an application programming interface, that executes structured queries to retrieve, insert, update, or delete data in the information storage medium.

The term “general-purpose information processing resource” refers to a computing hardware and software environment, such as a central processing unit executing an operating system and application programs, that is capable of performing various data processing tasks not limited to a specific application.

The term “missing-value completion processing” refers to an automated data processing operation that detects absent data entries in a dataset and fills such entries using predetermined rules, such as interpolation, substitution with statistical values, or propagation of neighboring values.

The term “outlier removal processing” refers to an automated data processing operation that detects and excludes data points that deviate from expected ranges or patterns, based on predefined thresholds or statistical criteria, in order to improve data quality.

The term “attribute transformation processing” refers to a data processing operation that converts original attributes of data into derived attributes, such as converting a timestamp into a day-of-week indicator or aggregating detailed records into summarized metrics.

The term “categorical-information numerical conversion processing” refers to a data processing operation that converts non-numeric categorical values, such as labels or categories, into numeric representations suitable for machine learning or numerical analysis.

The term “normalization processing” refers to a data processing operation that scales or adjusts numerical values of features to a common range or distribution, such as by min-max scaling or standardization, to stabilize machine learning behavior.

The term “learning input data” refers to a set of processed feature values used as input variables for training a prediction model in a machine learning process.

The term “teaching data” refers to a set of target values or labels corresponding to the learning input data, used by a machine learning algorithm to adjust model parameters during training.

The term “prediction mathematical model” refers to a computational representation, such as a regression model, a neural network, or another statistical or machine learning model, that maps input feature values to predicted output values.

The term “machine learning program” refers to software instructions executed by a computing resource to implement a machine learning algorithm, including at least model definition, training, and inference procedures.

The term “general-purpose numerical computation resource” refers to a hardware and software platform, such as a central processing unit, a graphics processing unit, or an accelerator, in combination with numerical libraries, that performs arithmetic operations for training and executing mathematical models.

The term “prediction input data” refers to feature values prepared for inference by the prediction mathematical model, including at least the latest business information, the latest user visit information, and future environmental information.

The term “future business indicators” refers to predicted quantitative measures of future business performance, such as forecasted sales amounts or transaction counts, output by the prediction mathematical model.

The term “future user visit indicators” refers to predicted quantitative measures of future user or customer visits, such as forecasted visit counts or visit frequency, output by the prediction mathematical model.

The term “inference processing” refers to execution of the prediction mathematical model with prediction input data to compute predicted outputs, including the future business indicators and the future user visit indicators.

The term “high-demand period” refers to a time interval determined, based on prediction results and predetermined conditions, to have a relatively high expected business activity or user visit level compared to a reference value.

The term “low-demand period” refers to a time interval determined, based on prediction results and predetermined conditions, to have a relatively low expected business activity or user visit level compared to a reference value.

The term “structured advice information” refers to machine-readable data that describes recommended actions or plans, including at least identifiers of recommended periods, action types, and resource allocation values, organized in a predefined data structure.

The term “action plan candidate” refers to a proposed operational action, such as an event, promotion, or schedule adjustment, represented in structured advice information for potential execution.

The term “resource allocation candidate” refers to a proposed distribution of limited resources, such as budget, personnel, or inventory, across time periods or activities, represented in structured advice information.

The term “explanation data” refers to data to be converted into natural language, including at least structured advice information and results of the inference processing, that together describe prediction outcomes and corresponding recommendations.

The term “generative information generation model” refers to a parameterized computational model, such as a generative artificial intelligence model, configured to produce natural language or other structured outputs in response to input text or data.

The term “prompt sentence” refers to a text string or sequence of symbols that is input to the generative information generation model in order to instruct or condition the model to generate a particular type of output.

The term “advice sentence” refers to natural language text generated by the generative information generation model, describing recommendations or guidance based on the structured advice information and prediction results.

The term “transmission information” refers to data formatted for communication over a network, including at least the advice sentence and the results of the inference processing, and optionally metadata for delivery to a portable information terminal.

The term “portable information terminal” refers to a user-carried electronic device, such as a handheld communication device or mobile computing device, capable of communicating with a server via a communication network and presenting information on a display.

The term “communication network” refers to an interconnected communication infrastructure, including wired or wireless links and network devices, that enables data exchange between the server and one or more terminals.

The term “output data” refers to information prepared for presentation to a user on a terminal, including at least the advice sentence and prediction results, in a format suitable for display or interaction.

The term “evaluation information” refers to data representing a user's assessment of system-generated advice, such as accept, reject, or rating values, obtained through user operations on a terminal.

The term “selection information” refers to data representing a user's selection or modification of action plan candidates or resource allocation candidates, obtained through user operations on a terminal.

The term “generation conditions of the structured advice information” refers to internal parameters, rules, or thresholds used by the server to derive structured advice information from prediction results.

The term “generation conditions of the prompt sentence” refers to internal parameters, templates, or rules used by the server to construct the prompt sentence for the generative information generation model.

The term “learning conditions of the prediction mathematical model” refers to configuration parameters for training the prediction mathematical model, including at least learning rates, training durations, loss functions, and feature selection policies.

In one embodiment, a server cooperates with at least one terminal operated by a user to implement the claimed system. The server includes a processor, a main memory, a non-transitory storage device, and a network interface. The processor executes an operating system, a database management component, a machine learning framework, and an application program that implements the data preprocessing, prediction, structured advice generation, and prompt sentence construction described below. The terminal includes a processor, a display, an input interface such as a touch panel, a memory, and a communication interface, and executes a client application that displays prediction results and advice sentences and acquires feedback from the user.

The server stores past business information, user visit information, and environmental information in an information storage medium such as a relational database stored on a magnetic disk drive or a solid-state drive. The server uses a database management system, for example software compatible with a structured query mechanism such as SQL, to store records in tables. Each record may include, as a data structure, fields such as a date key, a business metric (for example, sales amount), a user visit count, and an environmental attribute (for example, weather category or calendar type). The server accesses this information storage medium by issuing structured queries from an application program written in a general-purpose programming language, and loads acquired data sets into main memory as in-memory data structures, such as tabular arrays or matrices.

The server performs preprocessing on the acquired data sets on the general-purpose information processing resource. The server detects missing entries by scanning each column and identifying null or empty values. The server performs missing-value completion processing by applying an algorithm such as forward filling, median substitution, or grouped mean substitution, depending on data type and column statistics. The server performs outlier removal processing by computing, for each numeric feature, a distribution measure such as a standard deviation or interquartile range, and then removing or capping values outside a predefined multiple of such measures. The server performs attribute transformation processing by deriving new features from raw attributes, for example by converting date fields into weekday indices, weekend flags, holiday flags, and rolling aggregates of business indicators over predefined windows.

The server performs categorical-information numerical conversion processing by mapping categorical values such as weather labels into numeric vectors. In one example, the server represents each category as a one-hot vector embedded in a numeric feature space to be used by a machine learning framework. The server then performs normalization processing on continuous features. For example, the server computes, for each feature, the mean and standard deviation over a training period and standardizes each value by subtracting the mean and dividing by the standard deviation. The server stores normalization parameters in a configuration data structure so that the same transformation can be applied consistently during later inference. Through these preprocessing stages, the server generates learning input data as a feature matrix and teaching data as one or more target vectors aligned by time index.

The server constructs a prediction mathematical model by using a machine learning program operating on a general-purpose numerical computation resource. In one embodiment, the server uses a neural network framework that supports definition of dense layers, activation functions, and loss functions. The server defines a feed-forward neural network that receives as input a feature vector containing normalized business, visit, and environmental features for a particular date or time unit, and outputs predicted business indicators and predicted user visit indicators for a future date or time unit. The server configures the neural network with, for example, several hidden layers having rectified linear unit activations, a multi-dimensional output layer, and a loss function such as mean squared error computed between predicted values and teaching data values.

The server executes a training algorithm such as mini-batch gradient descent with an adaptive optimizer. The server computes the gradient of the loss function with respect to model parameters and updates weight parameters in the direction that reduces the loss. The server may apply regularization techniques, such as L2 penalty on weights or dropout, to improve generalization. The server records learning conditions such as learning rate, batch size, and number of epochs in a configuration file so that these conditions can be adjusted or re-used when the model is retrained. The server stores the resulting prediction mathematical model, including learned parameters and architecture metadata, in a storage device in a format that can be loaded efficiently for inference.

The server executes inference processing by preparing prediction input data that reflects latest business information, latest user visit information, and future environmental information. For example, the server acquires updated transaction records and visit logs up to the current date, as well as forecasted environmental data such as future weather categories and calendar flags.

The server applies the same attribute transformation and normalization parameters that were used during training. The server then inputs the resulting feature vectors to the trained neural network and performs forward propagation to compute predicted outputs. The server thereby generates future business indicators, such as forecasted sales values, and future user visit indicators, such as forecasted visitor counts, for each target date.

The server generates structured advice information by applying a rule engine to the predicted indicators. The server compares predicted user visit indicators and business indicators against baseline values such as historical averages or quantiles. If a predicted indicator exceeds a predetermined threshold, the server designates the corresponding period as a high-demand period. Conversely, if a predicted indicator falls below a second threshold, the server designates the corresponding period as a low-demand period. Based on such designations, the server generates action plan candidates, such as scheduling a promotional event or adjusting resource allocation, and resource allocation candidates, such as assigning a proportion of a budget or personnel to particular periods. The server encodes these candidates in structured advice information, for example in a record structure containing fields for target date, recommended action type, recommended intensity, and recommended allocation ratio.

The server generates explanation data by combining the structured advice information with the results of the inference processing. The server creates a data object that includes, for each time unit, the predicted indicators and corresponding action plan and resource allocation flags. The server prepares numerical summaries such as ranges, averages, and peak values, and associates them with descriptive labels. The server uses this explanation data as the basis for constructing a prompt sentence to be input to a generative AI model.

The server automatically generates a prompt sentence by applying a template-based construction algorithm. The server selects a language template according to the type of advice to be requested from the generative AI model. The server inserts summarized numerical information, categorical information, and period information derived from the inference results and structured advice into placeholders of the template. For example, the server may generate a prompt sentence such as:
“Using the following data for the next 7 days:
   Dates and predicted visitor counts: [2026 Feb. 1:120, 2026 Feb. 2:95, 2026 Feb. 3:130, 2026 Feb. 4:160, 2026 Feb. 5:210, 2026 Feb. 6:250, 2026 Feb. 7:260]
   Dates and predicted sales (yen): [same order: 350000, 320000, 380000, 420000, 500000, 560000, 590000]
Weather forecast: mostly sunny on Friday and Saturday

You are a business consultant for a physical retail store.
1. Identify which days are best for holding in-store events.
2. Propose discount levels for each recommended day.
3. Allocate a total weekly marketing budget of 500,000 yen across the week, with emphasis on the most promising days.

Explain the reasoning clearly so that a store manager can act on your suggestions immediately.”

The server then transmits this prompt sentence and, in some implementations, additional machine-readable summaries to a generative AI model residing on the same server or on a remote computing system reachable via the communication network. The server specifies generation parameters such as maximum output length and response style in order to control processing load and output consistency. The server receives the advice sentence generated by the generative AI model and checks the content for formatting or semantic errors using rule-based validation, such as verifying that dates mentioned in the text match available forecast periods. The server may re-issue a modified prompt when validation fails, thereby improving robustness.

The server generates transmission information for delivering the advice sentence and the underlying prediction results to the terminal. The server constructs a response message including the natural language advice sentences, key numerical indicators, and metadata such as timestamps. The server compresses the response, if necessary, and selects an appropriate encoding to reduce transmission size. The server then sends this transmission information via the network interface using a communication protocol. By including only relevant summary values and omitting intermediate processing details, the server reduces communication load and improves response time from the perspective of the terminal.

The terminal receives the transmission information and reconstructs internal data structures representing the advice sentences and the prediction results. The terminal renders a user interface that displays, on the display, the advice sentences and visual representations of the forecast data, such as charts or lists. The terminal allows the user to perform input operations specifying acceptance, rejection, or modification of the presented action plan candidates and resource allocation candidates. For example, the terminal may present selectable controls corresponding to each recommended event date and budget allocation.

The user operates the terminal by viewing the displayed advice and prediction results and by selecting actions such as confirming a recommendation, changing a recommended date, or declining a proposed allocation. The terminal captures such operations as evaluation information or selection information. The terminal then sends this information back to the server as structured feedback messages.

The server receives the feedback messages and updates internal generation conditions. For example, if the user frequently rejects suggestions for low-demand periods but accepts suggestions for high-demand periods, the server modifies thresholds used in the rule engine so that future structured advice information is more aligned with the user's preferences while still grounded in predicted indicators. The server may also adjust prompt generation templates by modifying instructions or emphasis based on observed user interactions. Furthermore, the server may update learning conditions of the prediction mathematical model, such as assigning greater weight to periods where past predictions have shown higher error, thereby reducing future prediction error.

By integrating these components, the server improves technical performance of the overall system. The systematic preprocessing reduces noise and inconsistent data, which improves model accuracy and stabilizes numerical computation. The use of a dedicated neural network architecture with well-defined training procedures, such as gradient-based optimization and explicit error functions, improves prediction precision compared to simpler rule-based approaches. The automatic generation of prompt sentences from internal prediction results and structured advice information ensures that the generative AI model receives consistent, context-rich inputs, reducing the need for manual intervention and improving reproducibility of advisory outputs. The feedback loop from the terminal to the server allows adaptive adjustment of internal parameters, which leads to improved computational efficiency and reduced unnecessary network traffic over time, because the server can better target the content and timing of advice.

In another embodiment, the server uses a different type of prediction mathematical model, such as a recurrent neural network or a gradient-boosted decision tree ensemble, while maintaining the same data structures and feedback-based control flow. In yet another embodiment, the server deploys the generative AI model locally rather than relying on a remote service, and optimizes prompt generation and batch processing so that advice sentences are generated with lower latency. In still another embodiment, the server aggregates feedback from multiple terminals and uses aggregated statistics to adjust learning conditions in a federated manner, thereby improving system behavior across diverse deployment environments. In each embodiment, the server continues to perform programmatic, rule-governed transformations from raw data to predictions, to structured advice, to prompt sentences, and finally to natural language output, and uses user feedback to refine these transformations, thereby achieving a concrete improvement in the functioning of the computer system itself rather than merely automating human reasoning.

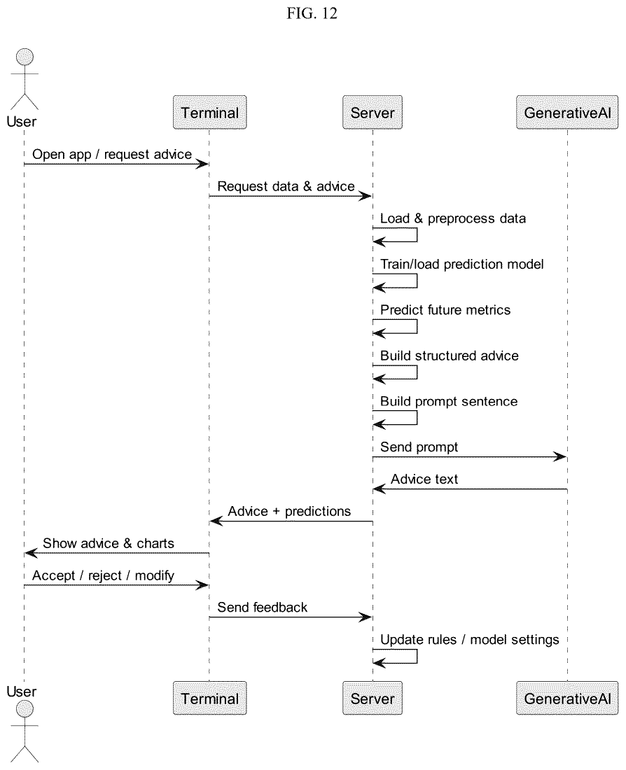

The following describes the processing flow using FIG. 12.

### Step 1:

Server acquires raw data from the information storage medium.

Server uses a structured query mechanism to input a query specification (for example, a time range and target store identifier) and outputs a raw data table containing past business information, user visit information, and environmental information.

Server executes a query such as “select date, business_metric, visit_count, environment_code from records where date between D1 and D2” and loads the result into main memory as an in-memory table or matrix.

### Step 2:

Server preprocesses the raw data to generate cleaned data.

Server receives, as input, the raw data table from Step 1 and outputs a cleaned data table.

Server scans each column to detect missing values, replaces missing numeric values using a predetermined rule (for example, group-wise mean or median), removes or caps outliers based on statistical thresholds, converts date strings into structured date-time objects, and flags weekends and holidays as separate binary features.

### Step 3:

Server converts categorical attributes and normalizes numerical attributes.

Server receives, as input, the cleaned data table and outputs a feature matrix suitable for machine learning.

Server maps categorical attributes such as environment_code to numeric vectors using a categorical-information numerical conversion method (for example, one-hot encoding), computes normalization parameters (mean and standard deviation) for each numeric column, and scales each numeric value to a standardized range.

### Step 4:

Server constructs learning input data and teaching data.

Server receives, as input, the feature matrix from Step 3 and outputs two aligned data structures: learning input data and teaching data.

Server selects, from the feature matrix, a set of feature columns as input variables and shifts target variables (for example, next-day business_metric and next-day visit_count) to construct teaching data. Server aligns rows by time index such that each input vector corresponds to the correct future output vector.

### Step 5:

Server trains the prediction mathematical model.

Server receives, as input, the learning input data and the teaching data from Step 4 and outputs a trained prediction mathematical model.

Server defines a neural network architecture with one or more hidden layers, initializes model parameters, computes forward outputs for each training batch, evaluates a loss function such as mean squared error, computes gradients by backpropagation, and updates weight parameters by gradient-based optimization until convergence or a maximum number of epochs is reached.

### Step 6:

Server stores the trained prediction mathematical model and associated parameters.

Server receives, as input, the trained model parameters and normalization parameters from Step 5 and outputs a stored model artifact.

Server writes model weights, network architecture metadata, and preprocessing parameters to a file or database entry, thereby enabling later loading for inference without retraining.

### Step 7:

Server prepares prediction input data for future periods.

Server receives, as input, latest business records, latest visit records, and future environmental information from the information storage medium and outputs a prediction input feature matrix.

Server applies the same cleaning, categorical conversion, attribute transformation, and normalization procedures as in Steps 2 and 3, ensuring that feature vectors for future dates have the same structure and scale as the training data.

### Step 8:

Server performs inference using the trained prediction mathematical model.

Server receives, as input, the stored model artifact from Step 6 and the prediction input feature matrix from Step 7 and outputs prediction results.

Server loads the model into memory, feeds each prediction input vector through the neural network to compute outputs, and generates arrays of future business indicators and future user visit indicators indexed by time unit.

### Step 9:

Server generates structured advice information.

Server receives, as input, the prediction results from Step 8 and outputs structured advice information.

Server computes baseline statistics such as average and variance of historical indicators, compares each predicted value with these baselines, classifies each period as high-demand or low-demand using predetermined thresholds, and creates action plan candidates and resource allocation candidates encoded as structured records associated with corresponding periods.

### Step 10:

Server composes explanation data from prediction results and structured advice information.

Server receives, as input, the prediction results and the structured advice information from Step 9 and outputs explanation data.

Server aggregates key values (for example, peak predicted visitor counts, minimum predicted sales, and recommended high-demand periods), attaches descriptive labels, and organizes them into a data object that can be summarized numerically and referenced by period.

### Step 11:

Server constructs a prompt sentence for the generative AI model.

Server receives, as input, the explanation data from Step 10 and outputs a prompt sentence in natural language.

Server selects a prompt template, inserts summarized prediction values, period descriptions, and action plan candidates into designated placeholders, and appends instructions directing the generative AI model to generate predictions and proposals. For example, the server generates:
“Using the following data for the next 7 days:
   Dates and predicted visitor counts: [2026 Feb. 1:120, 2026 Feb. 2:95, 2026 Feb. 3:130, 2026 Feb. 4:160, 2026 Feb. 5:210, 2026 Feb. 6:250, 2026 Feb. 7:260]
   Dates and predicted sales (yen): [same order: 350000, 320000, 380000, 420000, 500000, 560000, 590000]
   Weather forecast: mostly sunny on Friday and Saturday

You are a business consultant for a physical retail store.
1. Identify which days are best for holding in-store events.
2. Propose discount levels for each recommended day.
3. Allocate a total weekly marketing budget of 500,000 yen across the week, with emphasis on the most promising days.

Explain the reasoning clearly so that a store manager can act on your suggestions immediately.”

### Step 12:

Server transmits the prompt sentence to the generative AI model and obtains an advice sentence.

Server receives, as input, the prompt sentence from Step 11 and outputs an advice sentence in natural language.

Server sends the prompt sentence to the generative AI model, receives a generated text response, parses the response to identify main recommendations, and performs basic validation (for example, checking that referenced dates exist in the prediction horizon).

### Step 13:

Server generates transmission information for the terminal.

Server receives, as input, the advice sentence from Step 12 and the prediction results from Step 8 and outputs transmission information.

Server constructs a message that includes the advice sentence, selected predicted indicators, and associated metadata, applies optional compression or encoding, and prepares the message for delivery over a communication network.

### Step 14:

Server sends transmission information to the terminal.

Server receives, as input, the transmission information from Step 13 and outputs network packets directed to the terminal.

Server uses the network interface to send the message via a communication protocol to the terminal's address, and logs transmission status for monitoring.

### Step 15:

Terminal receives and parses the transmission information.

Terminal receives, as input, the network message from Step 14 and outputs internal data structures for advice and prediction display.

Terminal decodes the received message, separates the advice sentence and the prediction values, and stores them in memory as display-ready objects.

### Step 16:

Terminal renders a user interface showing the advice and forecasts.

Terminal receives, as input, the internal data structures from Step 15 and outputs visual content on the display.

Terminal draws text views containing the advice sentence, plots charts or lists based on the prediction results, and arranges interactive controls that allow the user to indicate acceptance, rejection, or modification of each action plan candidate and resource allocation candidate.

### Step 17:

User reviews the displayed advice and interacts with the interface.

User receives, as input, the visual content from Step 16 and outputs interaction events via touch or other input.

User reads the advice sentence, compares suggested actions and allocations with operational constraints, and selects interface elements to confirm, adjust, or decline specific recommendations.

### Step 18:

Terminal converts user interactions into feedback data.

Terminal receives, as input, the interaction events from Step 17 and outputs structured feedback information.

Terminal maps each user operation to a corresponding record indicating which recommendation was acted upon and how (for example, accepted, rejected, or modified amount), and packages these records as evaluation information or selection information.

### Step 19:

Terminal sends feedback data to the server.

Terminal receives, as input, the feedback information from Step 18 and outputs a feedback message over the communication network.

Terminal formats the feedback into a request message and transmits it to the server's feedback endpoint, awaiting acknowledgment.

### Step 20:

Server updates internal conditions based on feedback.

Server receives, as input, the feedback message from Step 19 and outputs updated generation conditions and learning conditions.

Server analyzes patterns in the feedback, adjusts thresholds and rules used for classifying high-demand and low-demand periods, updates parameters that control prompt sentence construction (for example, emphasis on certain metrics), and optionally modifies learning schedules or weighting schemes for the prediction mathematical model so that future predictions and advice become more aligned with reliable user-validated outcomes.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional business analytics systems typically separate numerical data processing from strategy generation and user-facing presentation. In many implementations, a first set of software components executes batch-style statistical processing over historical operation result information and user trend information stored in a database, a second set of components separately performs predictive modeling, and a third set of components manually assembles textual reports or dashboards. This fragmented architecture leads to several technical problems in computer operation.

First, conventional systems generally do not integrate time-series analysis, prompt generation for a generative artificial intelligence model, and interactive visualization within a single coherent processing pipeline controlled by a processor. As a result, the processor frequently performs redundant data transformations and repeated data transfers between heterogeneous modules, which increases memory usage, causes unnecessary input/output operations, and degrades overall processing latency on a computer system.

Second, when a generative artificial intelligence model is used, conventional systems often construct prompt sentences in an ad hoc or static manner, without systematically embedding machine-generated time-series indicators such as peak periods, low-activity periods, and seasonality indices. This leads to suboptimal token utilization and inadequate conditioning of the generative model, which in turn causes less accurate or inconsistent generation of prediction information and proposal information. From a computer-technical perspective, the absence of structured, feature-aware prompt generation reduces the effectiveness of the generative model's inference process and wastes computational resources at the model-execution side.

Third, existing dashboard systems frequently render visualizations and recommendations as separate, uncoordinated user interface elements. The processor typically serves charts and text outputs through independent interfaces, such that the information display terminal cannot efficiently synchronize user operations (for example, period designation or indicator selection) with underlying query processing, numerical computation, and generative artificial intelligence inference. This lack of tight coupling between user input handling and backend analytics forces the processor to perform repeated full-page refreshes or manual data exports, increasing network traffic and server load, and preventing real-time or near-real-time adaptive analytics.

Fourth, conventional implementations rarely allow a unified feedback loop in which user interactions on the information display terminal (including feedback information and condition changes) are used to automatically reconfigure data acquisition, time-series processing, prompt sentence generation, and generative inference. Consequently, the processor cannot dynamically adjust the analytical depth or generative output based on fine-grained interaction patterns. This results in inefficient utilization of computational resources and prevents the system from achieving an optimized balance between responsiveness and analytical sophistication.

Accordingly, there is a need for a computer-implemented technique that enables a processor to: (i) acquire, preprocess, and analyze time-series operation result information and user trend information in an integrated fashion; (ii) automatically generate structured, feature-aware prompt sentences for a generative artificial intelligence model based on numerical computation results; and (iii) tightly couple these analytics and generative functions with an interactive visualization pipeline, such that user operations on an information display terminal can drive end-to-end recomputation with reduced latency and improved resource efficiency. By solving these problems, the invention aims to improve the functioning of the computer system itself, including its data processing throughput, inference quality, and interaction responsiveness.

The specific processing by the specific processing unit 290 of the data processing device 12 in Example 2 is realized by the following means.

The present invention provides a server comprising a processor and a memory storing instructions, wherein the instructions, when executed by the processor, cause the processor to acquire operation result information and user trend information from an information storage unit by using a query language; convert the acquired operation result information and user trend information into a time-series data structure and perform numerical computation processing including missing-value completion, aggregation processing, moving-average calculation, and seasonality analysis on the time-series data structure; generate visualization-structured data including indicator values and trend information for each time unit based on a result of the numerical computation processing and generate screen display information by using a hypertext description language and a script language on the basis of the visualization-structured data; generate a prompt sentence including explanatory information that summarizes past indicator values, trend information, and seasonality information and provide the prompt sentence together with a feature vector extracted from the time-series data structure to a generative artificial intelligence model; receive a natural language output and/or structured proposal information including a business policy plan from the generative artificial intelligence model and generate integrated display information by associating the natural language output and/or the structured proposal information with the screen display information; and transmit the integrated display information to an information display terminal via a communication network and control the information display terminal to display, in response to a user operation, a visualization result of the operation result information and the business policy plan in a mutually referable manner. This enables the computer system to execute an end-to-end, feature-aware analytics and generation workflow in which time-series numerical computations, prompt sentence construction for the generative artificial intelligence model, and interactive visualization are tightly integrated, thereby reducing redundant data transformations and network transfers, improving inference quality of the generative artificial intelligence model, and enhancing overall processing efficiency and responsiveness of the server and the information display terminal.

The term “operation result information” refers to electronic data indicating outcomes of operations over time, including at least numerical or categorical values representing performance indicators such as transaction counts, revenue amounts, or other activity metrics stored in an information storage unit.

The term “user trend information” refers to electronic data indicating behavioral patterns of users over time, including at least visit frequency, access counts, interaction events, or other user behavior metrics stored in an information storage unit.

The term “information storage unit” refers to a hardware and/or software component configured to store and manage electronic data, including at least one non-transitory storage medium and a storage control program, such as a database management system or other structured data repository.

The term “query language” refers to a formal computer language used by a processor to specify data retrieval, filtering, and aggregation operations with respect to an information storage unit, including at least a language that allows selection of records, specification of conditions, and definition of result sets.

The term “time-series data structure” refers to an electronic data representation in which each data item is associated with a time index, and in which the data items are ordered or accessible according to temporal sequence to enable time-based numerical processing.

The term “numerical computation processing” refers to a series of algorithmic operations performed by a processor on numeric and/or categorical data, including at least missing-value completion, aggregation, moving-average calculation, and analysis of seasonality or other temporal patterns.

The term “missing-value completion” refers to a process in which a processor detects absent or undefined data entries and replaces such entries with substitute values determined according to a predefined rule, such as interpolation, forward filling, backward filling, or default value assignment.

The term “aggregation processing” refers to a process in which a processor combines multiple data items into summary values according to predefined groupings, including at least summation, averaging, counting, or other statistical summarization over a specified time unit or category.

The term “moving-average calculation” refers to a process in which a processor computes an average of data values within a sliding time window or index range, and outputs a sequence of smoothed values aligned with corresponding time indices.

The term “seasonality analysis” refers to a process in which a processor analyzes time-series data to detect and quantify repeating temporal patterns, cycles, or periodic fluctuations, and outputs components or indices representing such seasonal effects.

The term “visualization-structured data” refers to structured electronic data that encodes, for each display unit such as a time point or category, at least an indicator value and associated metadata required for rendering a visual representation on a display device.

The term “screen display information” refers to electronic information defining a layout, style, and content of a user interface, including at least markup descriptions, style descriptions, and executable scripts that, when processed by an information display terminal, cause graphical elements to be rendered.

The term “hypertext description language” refers to a markup language used to describe structural and semantic elements of a user interface screen, including at least definitions of text blocks, containers, and interactive components.

The term “script language” refers to an interpreted programming language executed by a client-side or server-side runtime environment, used to control user interface behavior, data retrieval, dynamic updates, and other logic associated with screen display information.

The term “prompt sentence” refers to a machine-readable textual instruction or query composed by a processor, including explanatory information and one or more requests, and intended to be input to a generative artificial intelligence model to guide generation of prediction information or proposal information.

The term “feature vector” refers to an ordered collection of numerical or encoded values derived from source data, each value representing a particular attribute, statistic, or transformed quantity, and formatted as an input suitable for processing by a machine learning model.

The term “generative artificial intelligence model” refers to a machine learning model configured to receive input information including at least a prompt sentence and optionally feature vectors, and to generate new data such as natural language text or structured proposals according to learned parameters.

The term “natural language output” refers to machine-generated textual data expressed in a human language, produced by a generative artificial intelligence model in response to input information including at least a prompt sentence.

The term “structured proposal information” refers to machine-generated data representing one or more recommended actions, plans, or parameter values encoded in a predefined data structure, such as key-value pairs, lists, or records, suitable for programmatic interpretation.

The term “business policy plan” refers to recommendation content indicating a future course of action in an operational context, including at least suggested timings, durations, allocations of resources, or risk-related considerations.

The term “integrated display information” refers to electronic information in which visualization-structured data and generative output data, including natural language output and/or structured proposal information, are associated in a unified format for joint presentation on a user interface.

The term “information display terminal” refers to a computing device including at least a display unit, an input interface, a communication interface, and a control unit, configured to receive screen display information and integrated display information from a server and to render interactive user interfaces.

The term “user operation” refers to an input action performed by a user via an information display terminal, including at least selection, designation, or modification of conditions, and entry of feedback information, through one or more input devices.

The server implements the invention by executing stored instructions on a processor and cooperating with an information storage unit and one or more terminals connected via a communication network. The server uses a general-purpose operating system and an application execution environment, and the server executes software modules including a data acquisition module, a time-series analysis module, a visualization data generation module, a generative AI interface module, and a user interaction control module.

The server stores operation result information and user trend information in the information storage unit, which may be implemented as a relational database system or a distributed data store. The server configures the information storage unit to maintain records that each include at least a time stamp field, one or more numeric indicator fields, and optional categorical fields. The server represents the records in a time-indexed data structure, such as a table where the time stamp is a primary key or part of a composite key, and the server arranges the records in chronological order to support efficient time-based retrieval and resampling.

The server acquires the operation result information and the user trend information by issuing queries expressed in a query language to the information storage unit. The server configures the queries to select only fields required for analysis, and to restrict the temporal range to a predetermined past period, thereby reducing the amount of data transferred from the storage medium to main memory. By limiting the query scope and directly projecting necessary fields into an internal time-series structure, the server reduces the number of read operations and the size of intermediate data, which improves data throughput and decreases latency relative to conventional systems that repeatedly load entire tables.

The server converts the acquired data into a time-series data structure maintained in system memory. The server assigns each record to a discrete time unit such as a day, week, or month, and the server aligns operation result information and user trend information onto a shared time axis. The server detects missing entries for numeric indicators by scanning the time axis for gaps, and the server completes missing values according to predetermined rules. In one embodiment, the server uses linear interpolation for gradually varying indicators and forward filling for piecewise constant indicators. The server selects the completion rule based on type descriptors stored for each field. This explicit rule-based completion avoids inconsistent manual input and provides reproducible behavior, which leads to smaller variance in downstream model inputs and improved stability of the generative AI model's inference.

The server performs aggregation processing on the time-series data by grouping records by the chosen time unit and computing summary statistics for each group. The server may compute sums, means, or counts over the operation result information and the user trend information. The server also calculates moving averages by sliding a fixed-length window along the time axis and computing central tendencies within each window. The server stores the resulting smoothed series as additional fields in the time-series data structure. The moving averages attenuate high-frequency noise and emphasize consistent patterns, which reduces the dimensionality of noisy fluctuations that the generative AI model must handle, thereby improving both training and inference efficiency.

The server applies seasonality analysis to the aggregated series. The server decomposes each time series into a trend component, a seasonal component, and a residual component by applying a decomposition algorithm configured with an explicit seasonal period. The server stores the seasonal component as a numeric index per time unit. Because the server uses an explicit parametric decomposition defined by period and model type, the server can generate stable seasonality indices that are re-usable across sessions and datasets. This structured representation of seasonality is different from simple human interpretation of graphics; it produces machine-consumable features that the server can feed directly into the generative AI model.

The server generates visualization-structured data by transforming the internal time-series representation into a collection of records that each contain a time identifier, one or more indicator values, smoothed values, and seasonality indices. The server removes redundant internal metadata and converts the remaining fields into a compact structure designed for rendering on the terminal. By separating an internal analysis-oriented representation from an external visualization-oriented representation, the server reduces communication overhead and allows the terminal to render complex time-series views based on concise data packets.

The server generates screen display information by embedding the visualization-structured data into a document structure defined by a hypertext description language and a script language. The server defines layout elements such as axis regions, chart containers, and text panels, and the server associates each layout element with specific fields in the visualization-structured data. The server configures script-language routines on the terminal to bind user input events to these fields, such that a change in selection by the user can be translated into specific filter conditions or time ranges for the server-side query and analysis pipelines.

The terminal receives the screen display information from the server over the communication network. The terminal executes a browser or similar runtime environment that interprets the hypertext description language and the script language and generates visual charts, controls, and text areas on a display unit. The terminal renders line graphs, bar charts, and other graphical indicators representing the aggregated and smoothed series. The terminal associates hover events and selection events with particular time units and indicators, and the terminal sends interaction parameters back to the server as structured messages.

The user operates the terminal by selecting time ranges, indicators, and conditions through the user interface controls. The user may, for example, select a last-twelve-month view, focus on a specific location category, or change the time granularity from weeks to months. The user can also open a panel that displays generated proposals and, where enabled, provide feedback regarding the relevance or usefulness of those proposals. The user input does not directly change the raw data; instead, the terminal translates the input into filter and configuration parameters and sends them to the server.

The server receives the parameters describing the user operation from the terminal, and the server uses these parameters to automatically reconfigure the queries to the information storage unit, the aggregation settings, and the seasonality analysis period. This tight coupling between user interaction and the internal analysis pipeline eliminates the need for manual data export and offline computation, and it enables real-time recomputation of views and generative outputs. Because the server restricts each recomputation to the subset of data and time ranges requested by the user, the server reduces unnecessary computation, which improves processing speed and reduces load on memory and storage interfaces.

The server constructs a prompt sentence for a generative AI model by combining static template text with dynamically computed summary information. The server inserts explicit references to detected peak periods, low-activity periods, and cyclical patterns as part of the explanatory portion of the prompt sentence. The server also appends a request portion that specifies what kind of predicted information and proposal information is required, such as a start date, duration, resource allocation, or risk factors. An example of such a prompt sentence is:

“Based on the past 12 months of sales and visitor data, where the peak sales occurred in 2022-12 and a steady increase was observed from 2022-10, please propose the optimal start date, duration, and key resource allocation for the next promotion campaign.”

Another example of a prompt sentence that a user may enter and the server may refine is: “Given our sales peak in December and the increase in visitors from October, propose a detailed promotion plan including timing, discount levels, and staffing recommendations.”

The server converts the summary statistics and seasonality indices into a feature vector aligned with the same time axis used in the time-series structure. The server normalizes the feature vector by applying scaling, centering, or whitening operations so that each dimension is mapped to a consistent numeric range. The server selects feature components based on an explicit feature selection rule stored in configuration, such as including aggregated indicators, moving averages, seasonality indices, and event markers. By using explicit selection rules tied to the internal structure of the time-series data, the server ensures that variations in the data schema do not silently break the generative AI pipeline. This explicit mapping is a technical improvement over ad hoc feature feeding that often leads to misaligned inputs and degraded model performance.

The server provides the prompt sentence and the feature vector as inputs to the generative AI model. The generative AI model may be implemented as a neural network having an encoder-decoder architecture with attention mechanisms. In one embodiment, the model includes an input embedding layer for textual tokens of the prompt sentence, an embedding projection for numeric features, one or more stacked transformer layers that combine token embeddings and feature embeddings, and a decoder that generates output tokens representing natural language recommendations. The server configures the model with a loss function that includes at least a cross-entropy term on output tokens and an auxiliary term that encourages consistency between predicted time-related actions and known seasonal peaks, as observed in training data. The server trains the model by iteratively adjusting weights using gradient-based optimization such as stochastic gradient descent or a variant with adaptive learning rates. The server performs backpropagation of errors through the embedding projections, attention weights, and decoder parameters.

During inference, the server executes the trained model on a hardware accelerator such as a graphics processing unit or tensor processing unit, thereby reducing computation time required to generate recommendations compared to a purely central-processing-unit-based implementation. The server applies constrained decoding rules to the generative AI model, such as restricting date outputs to feasible ranges and ensuring that recommended durations satisfy threshold constraints. These constraints are implemented as rule-based filters over model logits or as additional penalty terms during decoding, which reduces the generation of logically inconsistent or impossible outputs. This combination of learned behavior and explicit constraints constitutes a non-conventional, non-human-like processing method that improves both accuracy and robustness.

The server receives from the generative AI model a natural language output and, in some configurations, associated structured proposal information that encodes key elements of the recommendation such as proposed start dates, resource levels, and risk categories. The server associates these outputs with the corresponding time-series segments and indicator sets used in the analysis. The server embeds the natural language output into the screen display information as text elements and combines the structured proposal information with visualization-structured data to highlight relevant portions of the graphs or to overlay markers at recommended time intervals. This integrated association reduces cognitive load on users and eliminates the need for manual alignment between textual recommendations and visual data, thereby improving human-machine interaction efficiency.

The terminal displays the integrated visualization and recommendations so that the user can see both historical patterns and proposed future actions in a single interface. The user may, for example, see a line graph where a particular month is marked as a recommended start period and can immediately verify whether that recommendation aligns with past peaks and seasonal patterns. The user can then provide feedback via the terminal by marking recommendations as accepted, rejected, or needing adjustment. The terminal sends this feedback to the server, which can store it as additional training or evaluation data. Over time, the server can adjust feature selection rules or model hyperparameters based on observed feedback, thereby continuously improving the technical performance of the system.

The server realizes several technical effects that go beyond mere automation of human tasks. By maintaining explicit and compact time-series data structures combined with feature-aware prompt generation, the server reduces the number of transformation steps and intermediate data copies within the analytics pipeline, which improves memory locality and cache efficiency. By generating prompts that precisely encode statistical properties and seasonal structures, the server enables the generative AI model to converge faster during training and to require fewer tokens per inference, thus reducing computation and latency. By using the user operations on the terminal as triggers for selective recomputation and partial updates, the server reduces network traffic and avoids full-page reloads, which enhances scalability and responsiveness in multi-user environments.

The server also improves data management by establishing a well-defined mapping between database-level schemas, internal time-series structures, and visualization-structured data. This mapping ensures that additions or modifications to stored indicators can be propagated automatically through the pipeline with minimal reconfiguration. The explicit handling of missing values, seasonal decomposition, and smoothed series reduces numerical instability and decreases the propagation of noise into the generative AI model. As a result, the system exhibits lower variance in its predictions and a reduced error rate in the recommended timings and resource levels.

In alternative embodiments, the server may use different types of time-series decomposition algorithms, clustering algorithms, or dimension-reduction methods for preparing features for the generative AI model. The server may employ different normalization strategies or adaptively select the time window size based on recent variability in indicators. The generative AI model may use different architectures, such as recurrent neural networks with attention, convolutional sequence models, or hybrid models that combine rule-based engines with neural generation. The feature vector may be extended to include exogenous variables such as external event indicators or environmental conditions. The choice of algorithms and structures may vary, but in each case the server maintains the core characteristic of integrating numerical time-series analysis, feature-aware prompt generation, and synchronized interactive visualization in a unified computational pipeline.

The terminal can be implemented as a personal computer, a tablet, a smartphone, or a dedicated kiosk device, provided that it includes sufficient processing power to render the user interface and handle script-language execution. The user can operate the terminal in different environments, such as an office, a retail location, or a remote access scenario. The operation of the system may be adapted to various use cases where operation result information and user trend information are important, without changing the underlying technical approach of the server to processing time-series data, constructing prompt sentences, invoking a generative AI model, and producing integrated display information.

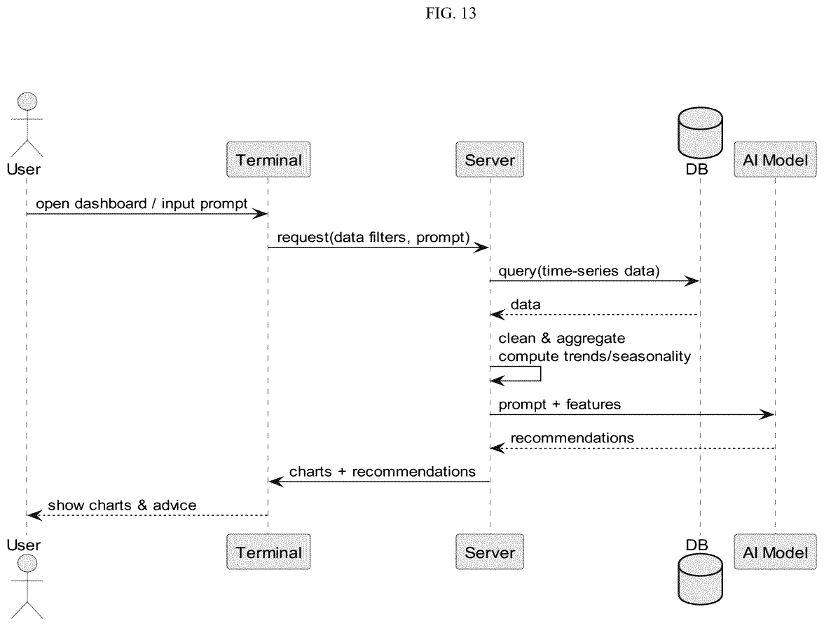

The following describes the processing flow using FIG. 13.

### Step 1:

The server receives, as input, a request from the terminal indicating a target time period and one or more indicator types.

The server uses this input to construct one or more queries defined in a query language and sends the queries to the information storage unit.

The server performs data retrieval operations that filter records by time range and indicator type and projects only necessary fields such as timestamps, numeric indicators, and category flags.

The server obtains, as output, a set of structured records ordered by time, each record including at least a time stamp and associated operation result information and user trend information.

### Step 2:

The server receives, as input, the structured records obtained in Step 1.

The server converts the records into a time-series data structure by assigning each record to a discrete time index and aligning multiple indicator series on a common time axis.

The server performs data processing by scanning the time axis for missing entries and detecting gaps or null values in each indicator field.

The server executes data calculation by applying predetermined completion rules such as interpolation or forward filling to replace missing numeric values.

The server produces, as output, a cleaned time-series data structure in which each time index has consistent indicator values suitable for analysis.

### Step 3:

The server receives, as input, the cleaned time-series data structure from Step 2.

The server performs aggregation processing by grouping the data into larger time units, such as months, and computing summary statistics including sums, means, and counts for each group.

The server executes data calculation for moving-average calculation by sliding a window of a predefined size along the time axis and computing smoothed indicator values at each position.

The server outputs an augmented time-series dataset that contains both aggregated values and moving-average values for each time unit.

### Step 4:

The server receives, as input, the augmented time-series dataset from Step 3.

The server performs seasonality analysis by decomposing each indicator series into a trend component, a seasonal component, and a residual component using a decomposition algorithm configured with a specific seasonal period.

The server executes data calculation by computing seasonal indices that quantify recurring patterns at each position within the seasonal cycle.

The server outputs a further enriched time-series data structure that includes the original indicators, aggregated values, moving averages, and seasonality indices per time unit.

### Step 5:

The server receives, as input, the enriched time-series data structure from Step 4

The server performs data processing by extracting for each time unit the time identifier, one or more indicator values, smoothed values, and seasonality indices, and by organizing these fields into a compact visualization-structured format.

The server executes data calculation only to convert internal numeric representations into display-friendly formats such as normalized scales or formatted time labels.

The server outputs visualization-structured data ready to be embedded into screen display information for rendering on the terminal.

### Step 6:

The server receives, as input, the visualization-structured data from Step 5.

The server generates screen display information by inserting the visualization-structured data into a document layout defined in a hypertext description language and associating dynamic bindings and event handlers defined in a script language.

The server performs data processing by mapping each indicator field to a specific chart element, axis, or legend entry and generating configuration data for interactive behaviors.

The server outputs a complete set of screen display resources, including markup, style, and behavior definitions, and transmits this output to the terminal via the communication network.

### Step 7:

The terminal receives, as input, the screen display resources transmitted by the server in Step 6.

The terminal parses the hypertext description and executes the script language to interpret the visualization-structured data and construct graphical elements.

The terminal performs data processing locally by transforming received indicator values into coordinate positions on charts and by generating graphical primitives such as lines, bars, and markers.

The terminal outputs an interactive visual interface on the display unit, including charts, controls, and text panels that represent the historical operation result information and user trend information.

### Step 8:

The user receives, as input, the visual interface displayed by the terminal in Step 7. The user performs operations such as selecting time ranges, choosing indicator types, or opening a recommendation panel.

The user may also input or edit a prompt sentence such as “Given our sales peak in December and the increase in visitors from October, propose a detailed promotion plan including timing, discount levels, and staffing recommendations.”

The user outputs, via interaction devices, one or more control actions and optional textual inputs that the terminal captures as user operation events.

### Step 9:

The terminal receives, as input, the user operation events and any prompt sentence entered by the user in Step 8.

The terminal performs data processing by converting these events into structured parameters describing selected time ranges, indicator filters, and text entries.

The terminal executes simple data calculation to validate parameter formats and to associate the user's prompt sentence with the current view context.

The terminal outputs a parameter message containing the filter conditions and prompt-related data and transmits this message to the server.

### Step 10:

The server receives, as input, the parameter message from the terminal in Step 9.

The server determines whether a recomputation of the time-series data or an update of the generative AI model inputs is required based on the changed parameters.

The server performs data processing by updating query conditions, aggregation settings, or seasonal period settings, and, if needed, re-executes Steps 1 through 4 on a narrower or modified dataset.

The server outputs an updated enriched time-series data structure that reflects the user-selected conditions.

### Step 11:

The server receives, as input, the current enriched time-series data structure from Step 10 and, where available, the user-entered prompt sentence.

The server performs data processing to summarize peak periods, low-activity periods, and characteristic changes in user trend information by extracting relevant statistics and time points from the time-series data.

The server executes data calculation to construct a feature vector by selecting and normalizing numerical indicators, moving averages, and seasonality indices according to predefined feature selection and scaling rules.

The server outputs a structured prompt sentence that includes explanatory text and explicit references to computed statistics, as well as a feature vector aligned with the time axis.

### Step 12:

The server receives, as input, the structured prompt sentence and the feature vector from Step 11.

The server passes the prompt sentence to a generative AI model as tokenized text and passes the feature vector as numerical input through a feature-embedding pathway.

The server executes data calculation inside the generative AI model, including forward propagation through an encoder-decoder or similar neural architecture, application of attention mechanisms, and generation of output token sequences that represent a natural language recommendation.

The server outputs a natural language output and, optionally, structured proposal information that encode recommended timings, durations, and resource allocations.

### Step 13:

The server receives, as input, the natural language output and structured proposal information from the generative AI model in Step 12.

The server performs data processing by associating recommendation elements with specific time units and indicators in the visualization-structured data, and by generating markers or highlight instructions for those units.

The server executes data calculation to derive any secondary metrics needed for display, such as expected increase ratios or resource utilization indices based on the recommended plan.

The server outputs updated integrated display information that combines charts, markers, and textual recommendations and transmits this integrated display information to the terminal.

### Step 14:

The terminal receives, as input, the integrated display information transmitted by the server in Step 13.

The terminal performs data processing by updating existing charts with additional markers, overlays, or annotations corresponding to the structured proposal information and by inserting the natural language output into designated text regions.

The terminal executes local data calculation, if necessary, to adjust chart scales or re-layout interface components so that recommended intervals are clearly visible.

The terminal outputs an updated interactive display in which the user can simultaneously view historical patterns, seasonality structures, and AI-generated business policy plans in a mutually referable manner.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional decision-support systems that generate business advice from historical sales data and visitor trends suffer from several technical limitations rooted in how computation is orchestrated and how models are driven.

First, conventional systems typically separate numerical prediction from natural-language recommendation generation, and drive recommendation logic with static, hand-crafted templates. As a result, a processing apparatus cannot systematically construct machine-interpretable context for a generative AI model, and cannot adapt the structure or content of prompt sentences based on changing data distributions. This static linkage between analytical pipelines and generative models leads to inefficient utilization of computational resources, rigid processing flows, and degraded quality and consistency of generated advice. Second, existing platforms often treat user emotion and sentiment as external or optional metadata and do not integrate multimodal emotion estimation into the core data processing pipeline. Behavioral logs, textual feedback, voice data, and image data are either ignored or handled in an ad hoc manner, without unified feature extraction and without feeding emotion signals back into model training or prompt construction. As a result, the processor cannot optimize its internal representations and cannot generate machine-learning features that jointly capture business trends and emotional context. This limits the ability of the system to prioritize compute cycles for the most impactful scenarios and to generate contextually appropriate advice.

Third, many systems do not implement a closed feedback loop between user interaction and model control. User acceptance or rejection of advice, explicit ratings, and realized business outcomes are rarely bound back to the prompt-generation logic and predictive models. Consequently, the processor cannot automatically refine the configuration rules of prompt sentences or adjust model hyperparameters based on empirical performance. This leads to unnecessary retraining cycles, suboptimal convergence of learning algorithms, and increased computational overhead in production environments.

Fourth, conventional architectures are not optimized for real-time anomaly-driven control of generative AI invocations. Real-time transaction streams and visitor measurements are often aggregated in coarse batches, and anomalies are processed manually or with simple alerts. There is no standardized mechanism in the processing apparatus to monitor streaming data against historical statistical distributions, detect outliers, and immediately synthesize dedicated prompt sentences to obtain short-term tactical advice from a generative AI model. This prevents efficient, event-driven orchestration of models and causes latency and instability in operational decision-making.

In summary, there is a need for a technical framework in which a processor: (i) unifies statistical preprocessing, feature extraction, and prediction; (ii) integrates multimodal emotion estimation into its core data structures; (iii) dynamically constructs and updates prompt sentences for a generative AI model based on analytical and emotional signals; and (iv) closes the loop with user feedback and real-time anomaly detection, so as to improve the efficiency, adaptability, and reliability of the underlying computer system itself, rather than merely automating a human business process.

The specific processing by the specific processing unit 290 of the data processing device 12 in Application Example 2 is realized by the following means.

The present invention provides a server comprising a processor configured to execute machine-implemented operations that (i) extract, from a storage apparatus, records relating to past business performance for corresponding periods and visitor trends, and perform statistical preprocessing including normalization and feature extraction to generate feature data; (ii) construct, using the feature data, a prediction model that estimates future business indicators and visitor indicators and stores analysis results including the estimated indicators; (iii) acquire user-related information including at least part of behavior history information, evaluation information, voice information, and image information, and estimate an emotional state of a user by applying natural language processing and emotion estimation techniques, thereby generating emotion data linked to the analysis results; (iv) dynamically construct, based on the analysis results and the emotion data, a prompt sentence as an input statement for a generative AI model, the prompt sentence including at least part of business performance information, visitor trend information, prediction result information, and emotional state information, and input the prompt sentence and the analysis results to the generative AI model to obtain advice information expressed in a natural language; (v) parse the advice information and format the advice information as structured advice data including at least part of an implementation timing, a resource allocation, a measure content, and a response policy, then generate visualization information based on the advice data and the analysis results and transmit the visualization information and the advice data to a user display apparatus; (vi) acquire feedback information including at least part of evaluation information, acceptance information, and implementation result information regarding the advice data from the user display apparatus, and update at least one of the prediction model, the emotion estimation techniques, and configuration rules that govern construction of the prompt sentence based on the feedback information; and (vii) monitor, in real time, transaction information and visitor measurement information, detect outliers with respect to past statistical distributions, and, upon detection of an outlier, generate an additional prompt sentence reflecting the outlier and invoke the generative AI model to obtain short-term tactical advice. This enables the computing system to automatically integrate analytical outputs and multimodal emotion signals into dynamically generated prompt sentences, to control invocation and adaptation of prediction and generative models based on real-time anomalies and user feedback, and thereby to improve the efficiency, responsiveness, and overall technical performance of the computer-based decision-support infrastructure.

The term “storage apparatus” refers to any hardware-based or virtual data storage component, including a memory device or a storage subsystem, that is configured to store records such as past business performance data, visitor trend data, feedback data, and model-related data in a machine-readable form.

The term “business performance” refers to a set of numerical or categorical indicators representing operational results of an enterprise, including but not limited to sales amounts, transaction counts, revenue, profit, and event outcomes, measured over defined time periods.

The term “visitor trends” refers to temporal patterns and statistical characteristics of incoming persons to a physical or virtual location, including visitor counts, visit frequency, dwell time, and distribution of visits across time intervals.

The term “statistical techniques” refers to computational procedures that analyze numerical data using statistical methods, such as aggregation, distribution analysis, outlier detection, correlation analysis, and time-series decomposition.

The term “feature extraction” refers to a computational process that transforms raw data into derived variables, including normalized values, encoded categories, temporal features, and aggregated indicators, which are suitable for input to a machine learning model.

The term “feature data” refers to a set of machine-readable variables generated by preprocessing and feature extraction, representing business performance, visitor trends, and related context in a structured numerical or categorical form.

The term “prediction model” refers to a machine-learned model, such as a regression model, classification model, or time-series forecasting model, that is trained to estimate future values of target indicators based on feature data.

The term “business indicators” refers to predicted or measured quantities that characterize business outcomes, including future sales, expected revenue, conversion rates, and other performance metrics.

The term “visitor indicators” refers to predicted or measured quantities that characterize visitor behavior, including future visitor counts, expected footfall by time slot, and probabilities of specific visitor patterns.

The term “analysis results” refers to information generated by the processor through statistical processing and prediction, including estimated indicators, confidence measures, detected trends, and anomaly flags.

The term “user-related information” refers to data associated with a user interacting with the system, including behavior history information, evaluation information, voice information, image information, and other signals collected from input devices and interfaces.

The term “behavior history information” refers to logs of user operations and activities, such as page transitions, button selections, dwell times, purchase actions, and session sequences, recorded over time by the system.

The term “evaluation information” refers to explicit or implicit assessments provided by a user, including ratings, satisfaction scores, textual comments, approvals, rejections, and qualitative feedback regarding advice or system outputs.

The term “voice information” refers to audio data captured from the user, including speech signals and vocal characteristics, which can be analyzed to extract linguistic content or paralinguistic features such as tone and prosody.

The term “image information” refers to visual data captured from the user or environment, including still images and video frames, which can be analyzed to detect facial expressions, gestures, and other visual cues.

The term “emotional state” refers to an inferred psychological condition of a user, such as satisfaction, frustration, interest, or indifference, as determined by applying emotion estimation techniques to user-related information.

The term “emotion data” refers to machine-readable representations of an emotional state, including categorical labels, probabilistic scores, and temporal profiles associated with specific users, sessions, or events.

The term “natural language processing” refers to computational techniques that process human language expressions in text or speech form, including tokenization, parsing, sentiment analysis, and semantic interpretation.

The term “emotion estimation techniques” refers to algorithms and models that infer an emotional state from input signals such as text, behavior logs, voice information, and image information, using statistical or machine-learning methods.

The term “generative AI model” refers to a machine learning model, such as a language model or multimodal generative model, that is configured to produce output data, including natural language text, in response to input data and prompt sentences.

The term “prompt sentence” refers to a machine-generated or manually defined textual input statement that conditions the behavior of a generative AI model, specifying context, constraints, and requested output content.

The term “business performance information” refers to a subset of business performance data, including historical values, aggregated statistics, and summarized indicators, formatted for inclusion in a prompt sentence or internal analysis.

The term “visitor trend information” refers to a subset of visitor trends data, including historical counts, peak patterns, and trend descriptions, formatted for analysis or for inclusion in a prompt sentence.

The term “prediction result information” refers to data representing outputs of a prediction model, such as estimated future indicators, prediction intervals, and associated metadata.

The term “emotional state information” refers to descriptions or encodings of emotional states that are included in system outputs or prompt sentences, enabling a generative AI model to account for user emotion.

The term “advice information” refers to natural-language text generated by a generative AI model in response to a prompt sentence, containing suggested actions, strategies, or explanations.

The term “structured advice data” refers to a machine-readable representation of advice information, organized into fields such as implementation timing, resource allocation, measure content, and response policy.

The term “implementation timing” refers to a temporal specification, such as a date, time, or time window, indicating when a recommended action or measure should be executed.

The term “resource allocation” refers to a recommendation regarding the distribution or assignment of resources, including personnel, budget, inventory, and capacity, across activities or time periods.

The term “measure content” refers to the substantive description of an action or measure to be taken, such as a promotion type, an event plan, or a configuration change.

The term “response policy” refers to rules or guidelines describing how to respond to a particular situation or user state, including customer interaction strategies and contingency actions.

The term “visualization information” refers to data structures that describe graphical or tabular representations of analysis results and advice data, including configurations for charts, graphs, dashboards, and other visual formats.

The term “user display apparatus” refers to any terminal or device, such as a workstation, mobile device, or display system, that presents visualization information and advice data to a user.

The term “feedback information” refers to data received from the user display apparatus that indicate user reactions or outcomes, including evaluation information, acceptance information, implementation result information, and related metadata.

The term “acceptance information” refers to data indicating whether a user has accepted, rejected, or modified a piece of advice, including explicit selection flags and associated timestamps.

The term “implementation result information” refers to data describing actual outcomes of implementing advice, including realized business indicators, deviations from predictions, and notes on execution.

The term “configuration rules of the prompt sentence” refers to machine-readable specifications that define how prompt sentences are constructed, including templates, content selection criteria, ordering of elements, and constraints.

The term “transaction information” refers to records of operations involving exchange of value, such as sales transactions, service orders, and related financial or operational events.

The term “visitor measurement information” refers to real-time or near-real-time data indicating the presence and count of visitors, collected by sensors, counters, or digital interaction logs.

The term “outlier” refers to a data point or pattern that deviates from an expected range defined by a historical statistical distribution, as determined by an outlier detection technique.

The term “short-term tactical advice” refers to advice data that specify actions to be taken within a relatively short future time horizon, focusing on immediate operational adjustments in response to detected anomalies.

The term “dashboard format” refers to a graphical layout that presents multiple visualization elements and advice elements concurrently on a user display apparatus, allowing the user to view aggregated status and controls in a single interface.

The term “filtering operation” refers to a user-initiated action that restricts displayed data or advice to subsets defined by criteria such as period, location, or item.

The term “regeneration of the advice” refers to a process of generating new advice information by invoking the generative AI model again, typically with an updated prompt sentence or updated context.

The term “evaluation indices of the prediction model” refers to numerical metrics used to assess the performance of a prediction model, such as error measures, accuracy scores, and stability indicators.

The term “configuration elements of the prompt sentence” refers to components that constitute a prompt sentence, including contextual descriptions, data summaries, instructions, constraints, and requested output formats.

The term “constraint conditions” refers to rules or limitations specified within or associated with a prompt sentence, such as length limits, tone requirements, or domain restrictions for the generative AI model output.

The term “output format of the prompt sentence” refers to specifications of the structure and style of the output expected from the generative AI model, including lists, tables, step-by-step instructions, or narrative text.

In one embodiment, a server, at least one terminal, and a user cooperate to implement a decision-support system that generates advice by integrating prediction models, multimodal emotion estimation, and a generative AI model driven by a dynamically constructed prompt sentence. The server executes software modules on general-purpose computing hardware such as a multi-core processor, a volatile memory, a non-volatile storage apparatus, and a network interface controller. The server software can be implemented using a programming language such as Python and can employ libraries such as a data-frame processing library, a statistical analysis library, a machine-learning library, a deep-learning library, a visualization library, and a natural language processing library. The terminal executes a client application on a computing device such as a smartphone, a tablet, a notebook computer, or a head-mounted display, and includes at least a display, an input interface, and optionally a camera and a microphone.

Server uses a relational database system, such as a generic SQL-compatible database, as the storage apparatus for business performance records, visitor trend records, user-related information, prediction results, emotion data, advice data, and configuration rules. Server organizes core business and visitor data into normalized tables, for example a table with fields (store_id, date, time_slot, sales_amount, transaction_count) and another table with fields (store_id, date, time_slot, visitor_count, dwell_time_distribution). Server stores user-related information in tables such as a behavior_log table with fields (session_id, user_id, timestamp, ui_event_type, ui_element_id, dwell_time), a feedback table with fields (feedback_id, user_id, item_id, rating, text_comment, created_at), and optional multimedia reference tables with fields linking to stored audio and image files. Server stores model-related metadata in tables that record model version identifiers, training timestamps, evaluation metrics, and feature configurations.

Server performs data preprocessing by loading raw records into in-memory data structures such as data frames. Server applies concrete statistical techniques to the data frames, including aggregation by group keys (for example, grouping by store_id and day_of_week), computation of mean, variance, and standard deviation, and detection of outliers by comparing each value to thresholds derived from a multiple of the standard deviation. Server calculates time-based features such as day_of_week, holiday_flag, and time_slot_index using date-time conversion functions and stores these derived features as additional columns in the data frame. Server performs feature extraction by applying, for example, one-hot encoding to categorical variables and by constructing lag features and rolling-window features, such as a feature representing the average sales_amount over the previous seven days or the previous four identical weekdays. These steps improve the ability of downstream models to capture temporal and categorical structure, thereby improving prediction accuracy and reducing the number of ad hoc business-specific rules that must be encoded manually.

Server constructs prediction models using a machine-learning library configured to train regression or time-series forecasting models. In one embodiment, server uses a gradient-boosted decision tree model with hyperparameters such as number_of_trees, maximum_tree_depth, and learning_rate. Server defines a feature vector for each training example that concatenates normalized business performance features, visitor features, calendar features, and, optionally, aggregated sentiment or emotion scores. Server trains the gradient-boosted tree model by minimizing a loss function such as mean squared error over predicted and actual sales_amount or visitor_count values. Server updates model parameters using a boosting procedure in which subsequent trees correct the residuals of prior trees. In another embodiment, server uses a neural network model constructed with a deep-learning library, for example a feedforward network with one input layer, multiple hidden layers, and one output layer. Server may set architectural parameters such as number_of_hidden_layers, number_of_units per_layer, activation functions (for example, rectified linear units), and regularization coefficients (for example, L2 penalty factor). Server trains the neural network using a stochastic gradient descent algorithm or a variant such as adaptive moment estimation, with a loss function such as mean absolute error or Huber loss, and updates network weights based on gradients computed by backpropagation. By explicitly combining calendar-based features, rolling-window statistics, and emotion-derived features within a unified feature vector, the prediction model achieves more stable and accurate forecasts compared to naive models that only observe raw sales counts.

Server implements emotion estimation by applying multiple algorithms to user-related information. For textual feedback (for example, text_comment fields), server uses a natural language processing library to tokenize text, remove stop words, and map tokens to vector representations (for example, word embeddings or bag-of-words counts). Server feeds these vectors into a sentiment classifier, which may be a logistic regression model or a shallow neural network, trained to output probability scores for categories such as positive, negative, and neutral. For behavioral data, server computes features such as normalized dwell time on specific screens, frequency of back-navigation events, ratio of abandoned carts to initiated checkouts, and response time to certain prompts. Server inputs these behavioral features into a classification model, such as a random forest or a small multilayer perceptron, to infer likely emotional states such as confusion, high interest, or frustration. For voice information and image information, server either calls an external emotion-recognition service or executes local convolutional or recurrent network models to classify facial expressions and vocal tone.

Server assigns each user session an emotion profile, represented as a vector of probabilities over discrete emotion labels, and stores this profile as emotion data associated with the session and with related business events.

Server combines the outputs of prediction models and emotion estimation into analysis results that capture both future business indicators and user emotional context. Server aggregates predicted business indicators (for example, predicted sales, predicted visitor_count) along axes such as store_id, date, and time_slot, and computes summary statistics such as expected peak periods, under-utilized periods, and estimated uncertainty ranges. Server similarly aggregates emotion data to determine, for example, typical emotional states during specific time windows or in association with particular product categories.

Server records analysis results in the storage apparatus in a structured form, for example using a table with fields (analysis_id, store_id, date, time_slot, predicted_sales, predicted_visitors, avg_sentiment_score, predominant_emotion_label).

Server dynamically constructs a prompt sentence for a generative AI model by applying prompt-configuration rules stored in the storage apparatus. These rules describe which analysis fields must be included, the order in which they appear, and constraint conditions, such as maximum textual length or required language. Server retrieves the relevant analysis results and emotion data, formats key metrics as textual summaries, and inserts them into a prompt template. For example, in one embodiment, server generates a prompt sentence of the form:
“Based on the attached time-series data of sales and visitor counts for the past 12 months, and considering that the model predicts a 25% increase in visitors during the second weekend of next month, please use the generative AI model to propose an optimal in-store event plan. The plan should include recommended dates, discount levels, target customer segments, and key performance indicators.”

In another embodiment, server generates an emotion-aware prompt sentence such as:
“Customer feedback for Product A shows increasing negative sentiment related to quality issues, and the emotion analysis indicates frequent ‘frustrated’ states during checkout. Using this information, please generate specific improvement actions for the product and a step-by-step customer communication strategy to recover satisfaction.”

In a real-time operational context, server constructs a prompt sentence such as:
“Using the current real-time point-of-sale data, visitor counts, and the weather forecast for the next 48 hours, please propose a detailed sales strategy for this weekend. Include recommended promotion types, optimal staff schedules by time slot, and inventory priorities for each main product category.”

Server transmits each prompt sentence, optionally together with compressed or summarized numerical context, to a generative AI model hosted locally or as a remote service. Server can use a transformer-based language model that includes multiple attention layers, feedforward layers, and layer normalization. Server sets the model's decoding parameters such as maximum_output_tokens, temperature, and top_k to control the variability of generated text.

The generative AI model processes the prompt sentence by computing contextual representations of the input tokens through multi-head attention and then generating output tokens one by one using learned probability distributions. By carefully structuring the prompt sentence with explicit business indicators and emotion labels, server constrains the search space of outputs and improves both the relevance and consistency of the generated advice.

Server receives advice information from the generative AI model in the form of natural-language text. Server parses the advice text to extract structured fields required by the system, such as date expressions, recommended staffing levels, discount percentages, and suggested response policies. Server may apply rule-based parsing or a secondary model that maps free text into a predefined schema, thereby generating structured advice data. Server stores the structured advice data in a table with fields such as (advice_id, analysis_id, recommended_start_time, recommended_end_time, recommended_staff_count, recommended_discount_rate, recommended_action_description, response_policy_summary).

Server generates visualization information by mapping analysis results and structured advice data into graphical configurations. Server prepares chart specifications describing, for example, a time-series graph of predicted_sales alongside historical_sales and markers indicating the recommended implementation timing, or a bar chart showing predicted staff workload per time_slot with annotations for recommended resource allocation. Server encodes these visualizations in a portable format and transmits both the visualizations and the associated advice data to the terminal across a network connection. Terminal receives the data and renders them on the display in a dashboard format that allows the user to inspect current and projected metrics and to review the recommended actions.

Terminal may also receive real-time updates from server when transaction information or visitor measurement information indicates anomalies. Server continuously monitors incoming transactional records and visitor counts, computes running aggregates over sliding windows, and compares these aggregates against expected values derived from historical statistical distributions or prediction model outputs. When server detects an outlier, such as a spike in visitor_count or an unexpected decrease in sales_amount, server immediately constructs an additional prompt sentence that describes the anomaly and requests short-term tactical advice from the generative AI model. Server then dispatches high-priority advice data and visual alerts to the terminal, enabling the user to respond promptly.

User interacts with the system via terminal by viewing visualization information and advice data, and by providing feedback information. User may indicate acceptance of specific recommended actions, modify certain parameters (for example, reducing recommended_discount_rate), or reject entire sets of advice. Terminal captures these decisions and associated rationales as feedback information and transmits them to server.

User may also rate the usefulness of advice and later input implementation result information, such as actual sales achieved during recommended event periods. Server incorporates this feedback into a feedback table and uses it to update prediction models and prompt-configuration rules.

Server implements learning control by analyzing correlations between advice data, user feedback, and realized business and visitor indicators. Server computes evaluation indices for the prediction model, such as mean squared error over new data, and evaluation indices for prompt configurations, such as advice acceptance rate or average usefulness rating per prompt template. Server then modifies hyperparameters of prediction models, retrains them on expanded datasets, and adjusts configuration rules for the prompt sentence. For example, if a specific template that emphasizes emotion data consistently yields advice with higher acceptance rates, server increases the weight of emotion-related fields in future prompt constructions. This feedback loop results in an adaptive system that improves its computational behavior over time, rather than simply repeating a fixed procedure.

This architecture yields technical advantages that affect the functioning of the computer system itself. Because server constructs feature-rich, normalized data and integrates emotion data into prediction and prompt generation, server reduces the need for storing and processing redundant rule sets, and instead allows machine-learning models to infer complex relationships more efficiently. Server reduces network bandwidth and latency by transmitting structured advice data and compact visualization configurations, rather than large raw datasets, to terminals. By employing real-time anomaly detection and event-driven prompt generation, server avoids continuous, expensive generative-model invocations and thereby reduces computational load while reacting rapidly to significant events. Furthermore, by using feedback information to adjust model parameters and prompt composition rules in an automated way, server improves prediction accuracy and lowers error rates over time, which in turn reduces unnecessary re-computations and stabilizes model behavior.

In alternative embodiments, server may employ different machine-learning algorithms or neural network architectures, such as recurrent neural networks for time-series forecasting, convolutional neural networks for image-based emotion estimation, or encoder-decoder architectures for mapping structured analysis results directly into structured advice data.

Server may also vary the data structures used, for example by storing feature data in columnar storage for faster analytical queries or deploying a distributed file system and distributed computation framework to handle high-volume transaction streams. Terminal may be implemented as a web browser client rendering a web application, or as a native application on a mobile platform or wearable device. User-related information may be expanded to include additional input modalities such as gesture tracking or physiological sensing, which server can incorporate into emotion estimation modules. In each such variation, server continues to perform the integrated processing of statistical feature extraction, prediction, emotion estimation, prompt sentence construction, generative AI model interaction, structured advice extraction, visualization, and learning control, thereby improving the technical performance and adaptability of the overall computer-based decision-support system.

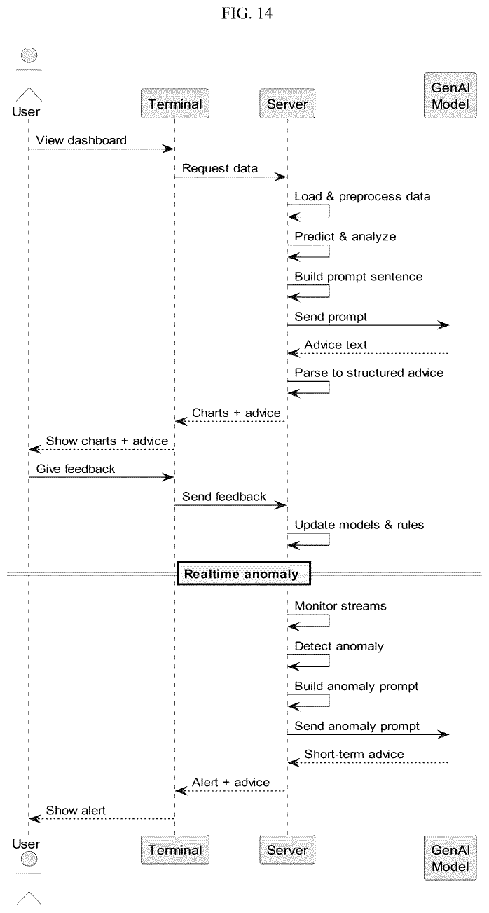

The following describes the processing flow using FIG. 14.

### Step 1:

Server acquires raw data.

Server receives, as input, records stored in a storage apparatus, the records including past business performance data, visitor trend data, user behavior logs, user feedback text, and multimedia references.

Server executes database queries to extract rows from business tables (for example, fields including store identifier, date, time slot, sales amount, and visitor count) and from user-related tables (for example, fields including session identifier, user identifier, UI event type, rating, and text comment).

Server outputs consolidated raw datasets, each organized as a data frame or equivalent in-memory table ready for preprocessing.

### Step 2:

Server preprocesses business and visitor data.

Server receives, as input, the consolidated raw datasets for business performance and visitor trends.

Server removes invalid records by checking for missing identifiers, impossible timestamps, or negative counts, and discards or corrects such entries.

Server computes derived time features by converting date and time fields into attributes such as day-of-week, month, holiday flag, and time-slot index.

Server normalizes numeric fields such as sales amount and visitor count by applying scaling functions that map values into a standardized range.

Server outputs cleaned and feature-augmented datasets that include original fields plus new time-based and normalized features.

### Step 3:

Server performs statistical aggregation and pattern analysis.

Server receives, as input, the cleaned and feature-augmented datasets.

Server groups data by keys such as store identifier and day-of-week and calculates aggregated statistics including means, medians, standard deviations, and counts for sales and visitor metrics.

Server detects anomalies by comparing current period metrics to historical distributions, computing z-scores or other deviation measures, and flagging records that exceed a configured threshold.

Server outputs analysis summaries that contain aggregated statistics, detected anomalies, and pattern descriptors such as peak periods and low-traffic periods.

### Step 4:

Server constructs feature vectors for prediction.

Server receives, as input, the feature-augmented datasets and the analysis summaries.

Server generates additional temporal features such as lagged values (for example, previous day's sales, previous week's same-day visitor count) and rolling-window statistics (for example, seven-day moving average of sales, four-week moving average of visitor count).

Server encodes categorical variables such as day-of-week and event type as numerical vectors using encoding methods.

Server composes, for each time point and store, a feature vector that concatenates normalized numeric values, encoded categorical variables, and temporal statistics.

Server outputs a training dataset and, for future periods, an inference dataset, each consisting of feature vectors paired with corresponding target indicators where available.

### Step 5:

Server trains prediction models.

Server receives, as input, the training dataset containing feature vectors and target indicators such as future sales or future visitor counts.

Server partitions the dataset into training and validation subsets, preserving temporal order where necessary.

Server applies a prediction algorithm, such as a regression ensemble or a neural network, to learn mappings from feature vectors to target indicators, minimizing a defined loss function over the training subset.

Server evaluates the trained model on the validation subset by computing error metrics such as mean squared error and mean absolute error.

Server outputs a trained prediction model and associated metadata, including learned parameters and performance metrics.

### Step 6:

Server performs prediction using the trained model.

Server receives, as input, the trained prediction model, associated scalers, and the inference dataset composed of feature vectors for future periods.

Server applies the prediction model to each feature vector to compute estimated values of business indicators and visitor indicators for future dates and time slots.

Server associates each prediction with its store identifier, time attributes, and optional confidence or uncertainty estimates derived from the model.

Server outputs prediction result information, stored as prediction records linking future time points to estimated indicators.

### Step 7:

Server processes user-related information for text-based emotion estimation.

Server receives, as input, user feedback text, review comments, and other text-based evaluations.

Server tokenizes each text entry, removes irrelevant tokens such as stop words, and transforms the remaining tokens into numerical representations such as term counts or embedding vectors.

Server applies a sentiment classification algorithm to each vector representation to compute sentiment scores and labels (for example, positive, neutral, negative) for each text entry.

Server aggregates sentiment per product, per store, or per period by averaging scores or counting category occurrences.

Server outputs sentiment data, including sentiment scores and labels associated with corresponding users, sessions, and business items.

### Step 8:

Server processes behavioral, audio, and image information for emotion estimation.

Server receives, as input, behavior logs (such as dwell times and navigation events), voice samples, and image frames associated with user sessions.

Server calculates behavioral features, such as mean dwell time on specific screens, frequency of rapid back-and-forth navigation, and ratios of abandoned interactions to initiated interactions.

Server either calls an external emotion-recognition function with voice and image data or applies local models to classify signals into discrete emotional states such as satisfaction, frustration, or curiosity.

Server fuses behavioral features with classification outputs to form an emotion profile for each session, represented as probabilities or weighted scores over emotion categories.

Server outputs emotion data that link each session, user, or context with an estimated emotional state.

### Step 9:

Server integrates prediction results and emotion data into analysis results.

Server receives, as input, prediction result information from the prediction model and sentiment and emotion data from the emotion estimation steps.

Server joins prediction records with emotion records on keys such as store identifier, time window, and session identifiers, thereby aligning predicted indicators with typical or observed emotional states.

Server computes composite indicators, such as predicted sales under conditions where predominant user emotion is positive or negative, and determines segments where emotion and business indicators conflict or align.

Server organizes these composite indicators into structured analysis results, each analysis result including business indicators, visitor indicators, and associated emotion information.

Server outputs analysis results stored in a structured format for further processing.

### Step 10:

Server constructs a prompt sentence for the generative AI model.

Server receives, as input, the analysis results that include prediction result information, visitor trend information, and emotional state information.

Server selects a prompt template based on configuration rules, such as whether an event-planning scenario, an improvement-action scenario, or a real-time-tactics scenario is required.

Server fills template slots with factual values from the analysis results, such as time periods showing increased visitor predictions, dominant negative sentiment causes, or real-time anomalous spikes.

Server concatenates these filled segments into a coherent prompt sentence that explicitly instructs a generative AI model to output a requested type of advice.

Server outputs the constructed prompt sentence and, if applicable, a compact representation of the underlying analysis context.

### Step 11:

Server calls the generative AI model and receives advice information.

Server receives, as input, the prompt sentence and optional contextual data.

Server sends this input to a generative AI model endpoint that processes the prompt sentence and computes natural-language output representing advice information.

Server receives the generated text and verifies it against internal constraints, such as maximum length and avoidance of prohibited terms, rejecting or truncating output that violates constraints.

Server outputs validated advice information in text form, linked to the originating analysis and prompt sentence.

### Step 12:

Server converts advice information into structured advice data.

Server receives, as input, the validated advice information in natural-language text.

Server parses the text using rules or secondary models to detect key entities and parameters, such as recommended dates, levels of discount, recommended staff counts, and proposed response policies.

Server maps these extracted parameters into predefined fields of an advice schema, creating one or more structured advice records per generated text.

Server stores the structured advice data in a storage apparatus for subsequent retrieval and visualization.

Server outputs structured advice data that can be programmatically processed and displayed.

### Step 13:

Server generates visualization information for the terminal.

Server receives, as input, analysis results and structured advice data.

Server constructs visualization specifications, describing charts and dashboards that combine predicted indicators, historical indicators, and recommended actions (for example, marking recommended event periods on a time-series chart of predicted and historical sales).

Server assembles layout definitions for a dashboard that includes panels for business indicators, visitor trends, emotion summaries, and advice summaries.

Server outputs visualization information encoded for interpretation by a terminal, together with associated advice data.

### Step 14:

Terminal retrieves and displays visualization information and advice.

Terminal receives, as input, visualization information and structured advice data from server.

Terminal renders charts, tables, and text panels on its display, arranging them in a dashboard format that shows key indicators and corresponding recommendations.

Terminal converts structured advice fields into readable sentences or labeled items and presents them on screen along with controls for user interaction.

Terminal outputs rendered user interface screens that allow user to view the current system state and the generated advice.

### Step 15:

User reviews advice and provides feedback.

User receives, as input, visualized indicators and advice displayed by terminal.

User evaluates the relevance and practicality of the advice and may accept, modify, or reject specific recommended actions via user interface controls.

User optionally enters free-text comments, ratings, or outcome notes describing actual or anticipated results of following certain recommendations.

User outputs feedback actions, which terminal captures as feedback information.

### Step 16:

Terminal transmits feedback information to server.

Terminal receives, as input, user selections, ratings, text comments, and implemented-status indicators regarding the advice.

Terminal formats feedback information into structured messages that include identifiers for analysis results, advice records, user identifiers, and timestamps.

Terminal transmits these messages to server over a communication channel, ensuring that each feedback event is acknowledged or queued for reliable delivery.

Terminal outputs feedback payloads that server can process to refine models and configuration rules.

### Step 17:

Server updates models and prompt-configuration rules using feedback.

Server receives, as input, feedback information and links it with associated analysis results, advice data, and realized business indicators.

Server computes evaluation indices such as advice acceptance rate, average user rating per prompt configuration, and deviation between predicted indicators and actual indicators for implemented advice.

Server adjusts prediction model hyperparameters, retrains models on extended training sets that include new data, and updates emotion estimation parameters to better align emotion categories with observed outcomes.

Server modifies configuration rules of the prompt sentence by enhancing templates and content selection logic that historically yielded higher acceptance or performance and de-emphasizing less effective elements.

Server outputs updated models and configuration rules that will influence future analyses and prompt sentence construction.

### Step 18:

Server performs real-time monitoring and anomaly-triggered advice generation.

Server receives, as input, continuously streaming transaction information and visitor measurement information.

Server maintains sliding-window aggregates and compares current metrics to historical baselines or recent model predictions, detecting outliers that exceed dynamic thresholds.

Server, upon detection of an outlier, immediately constructs a specialized prompt sentence describing the anomaly and desired planning horizon, then sends this prompt to the generative AI model and receives short-term tactical advice.

Server transmits this time-critical advice and associated alert visualization information to terminal, enabling rapid user response.

Server outputs anomaly-specific advice data that complement the regular planned recommendations.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

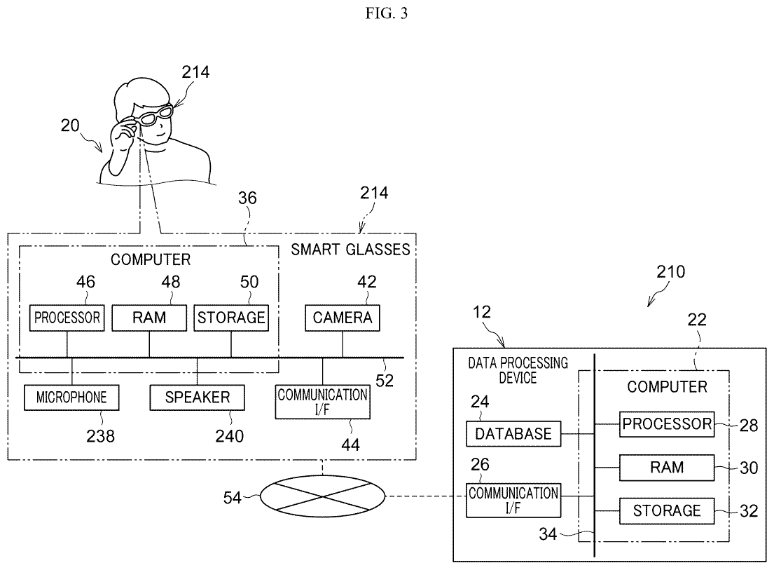

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

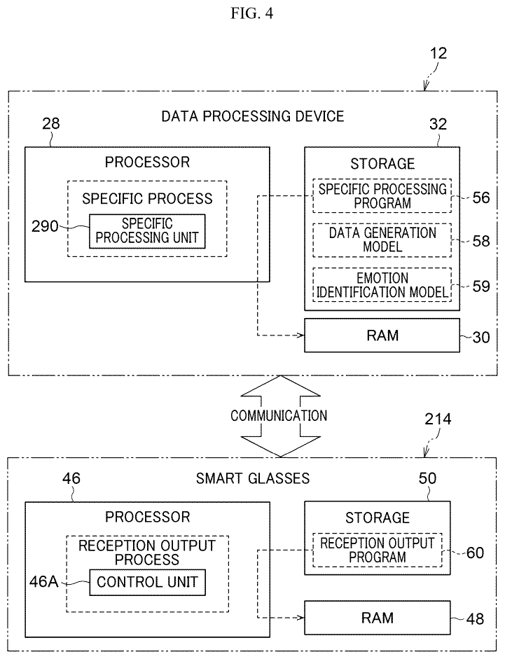

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

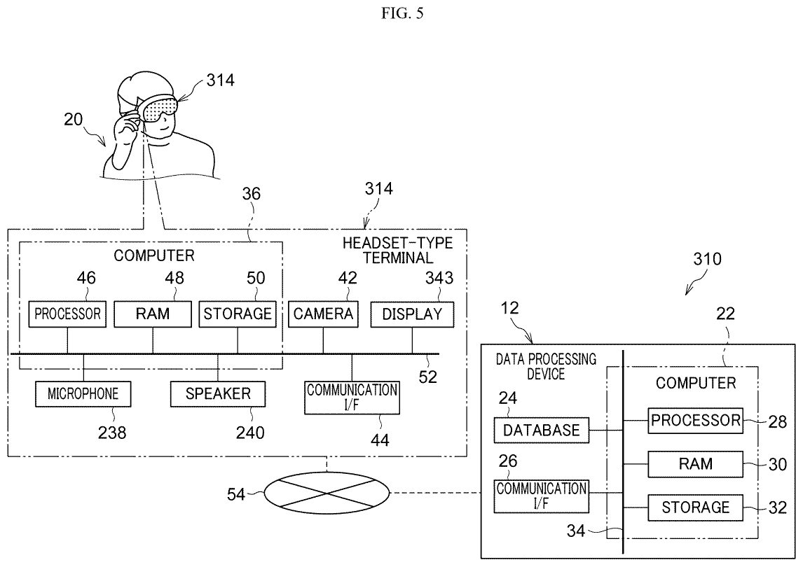

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

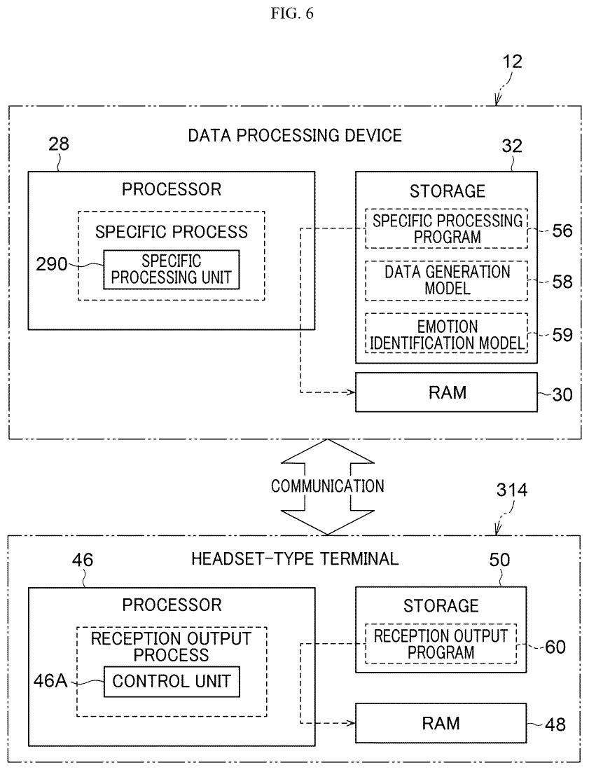

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

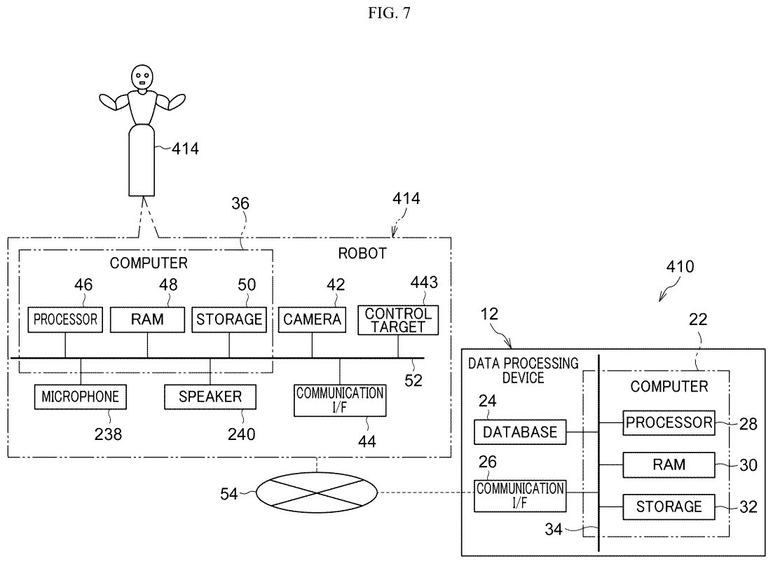

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

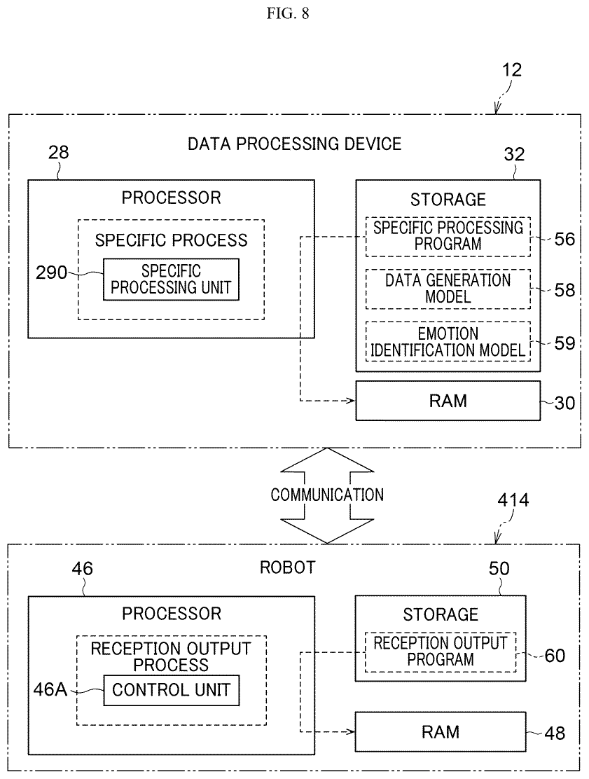

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

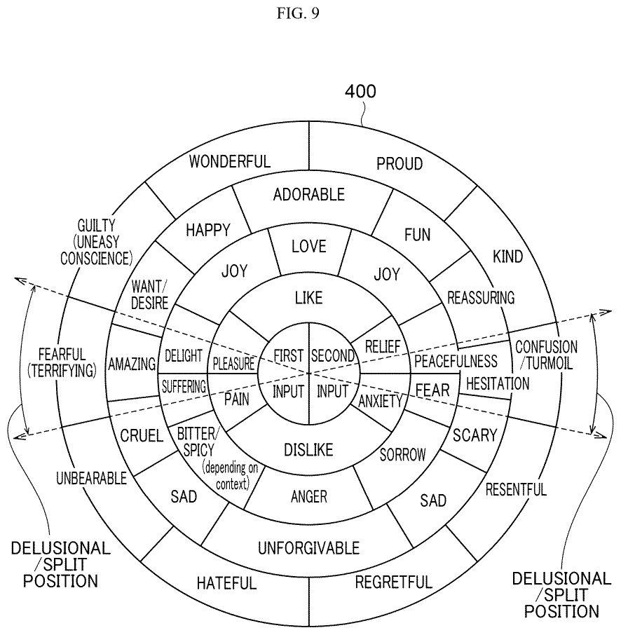

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles.

Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

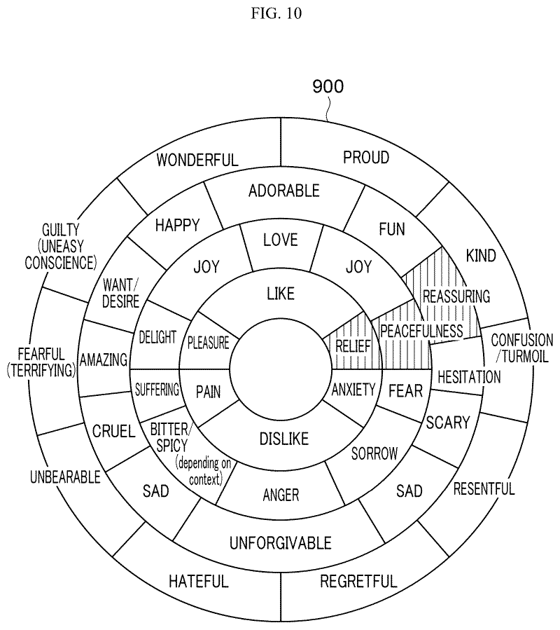

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire business information and visitor information from an external information processing apparatus via a communication unit and store the business information and the visitor information in a relational data storage unit,
obtain, from the relational data storage unit, the business information, the visitor information, event information, and environment information, perform preprocessing including missing-value completion processing, outlier processing, attribute transformation processing, and derived-attribute generation processing, and construct explanatory variables for machine learning processing,
generate a prediction model that outputs future business indicators and future visitor indicators by performing learning processing based on the explanatory variables and at least one of the business information and the visitor information, and calculate the future business indicators and the future visitor indicators by inputting new explanatory variables into the prediction model,
calculate a business measure plan including an event implementation date and a cost allocation based on the future business indicators and the future visitor indicators, and generate structured information representing the business measure plan,
generate a prompt sentence including explanation information that includes summarized numerical information and condition information of the structured information and including a natural language instruction relating to a business measure, and cause a generative artificial intelligence model to generate natural language advice relating to the business measure plan by inputting the prompt sentence into the generative artificial intelligence model, transmit the natural language advice and the business measure plan to a user apparatus and cause a display interface to display the natural language advice and the business measure plan,
receive, from the user apparatus, a user prompt sentence and user selection information or correction information relating to the business measure plan, generate a generative-artificial-intelligence-model prompt sentence by combining the user prompt sentence with the structured information, and cause the generative artificial intelligence model to generate additional natural language advice by inputting the generative-artificial-intelligence-model prompt sentence into the generative artificial intelligence model, and
record the user selection information or the correction information and at least one of the future business indicators and the future visitor indicators, and perform at least one of a relearning process of the prediction model and an update process of generation conditions of the prompt sentence based on the record.

### (Supplementary 2)

The system according to supplementary 1,
wherein the processor is configured to
generate the prompt sentence including numerical information that includes the future business indicators and the future visitor indicators, the business measure plan including the event implementation date and the cost allocation, and condition information indicating at least one of a target period, a target site, and a business condition to be explained, and including a natural language directive instructing the generative artificial intelligence model to generate an explanation of prediction content and proposal content, and cause the generative artificial intelligence model to generate a natural language prediction explanation and a natural language proposal explanation relating to the prediction content and the proposal content by inputting the prompt sentence into the generative artificial intelligence model.

### (Supplementary 3)

The system according to supplementary 1,
wherein the processor is configured to
provide the display interface that displays, in a time-series information display format and a dialogue information display format, the future business indicators and the future visitor indicators calculated by the prediction model, the business measure plan, and the natural language advice generated by the generative artificial intelligence model, and that accepts the user prompt sentence and feedback information from a user in the dialogue information display format and transmits the user prompt sentence and the feedback information to a server.

### Application Example 1

### (Supplementary 1)

A system comprising a processor,
wherein the processor is configured to
access an information storage medium storing past business information, user visit information, and environmental information, acquire the past business information, the user visit information, and the environmental information from the information storage medium by using a structured query mechanism, and load acquired data sets into a storage area of a general-purpose information processing resource,
perform preprocessing on the acquired data sets on the general-purpose information processing resource, the preprocessing including at least one of missing-value completion processing, outlier removal processing, attribute transformation processing, categorical-information numerical conversion processing, and normalization processing, and generate learning input data and teaching data,
construct a prediction mathematical model by using a machine learning program operating on a general-purpose numerical computation resource based on the learning input data and the teaching data, and store the constructed prediction mathematical model in a storage device, execute inference processing by inputting prediction input data, which reflects latest business information, latest user visit information, and future environmental information, into the prediction mathematical model, and output future business indicators and future user visit indicators,
generate structured advice information including at least one of an action plan candidate and a resource allocation candidate by determining, in accordance with predetermined conditions, a high-demand period and a low-demand period based on the future business indicators and the future user visit indicators obtained by the inference processing,
automatically generate a prompt sentence to be input to a generative information generation model, the prompt sentence being for converting explanation data, including the structured advice information and results of the inference processing, into a natural language expression, input the automatically generated prompt sentence and the explanation data into the generative information generation model, cause the generative information generation model to generate an advice sentence in natural language regarding contents of the structured advice information and the future business indicators and the future user visit indicators, and acquire a generation result,
generate transmission information for transmitting the acquired advice sentence and the results of the inference processing to a portable information terminal via a communication network, and distribute the transmission information as output data to be presented on the portable information terminal, and
update at least one of generation conditions of the structured advice information, generation conditions of the prompt sentence, and learning conditions of the prediction mathematical model based on evaluation information or selection information received from a user via the portable information terminal.

### (Supplementary 2)

The system according to supplementary 1,
wherein the processor is configured to
generate the prompt sentence as an explanatory text including at least a part of numerical information, categorical information, and period information that summarize the future business indicators, the future user visit indicators, the action plan candidate, and the resource allocation candidate, and append, to the explanatory text, wording that instructs the generative information generation model to create a prediction and a proposal.

### (Supplementary 3)

The system according to supplementary 1,
wherein the processor is configured to
cause the portable information terminal to generate a user display screen for displaying the advice sentence and the results of the inference processing, receive, on the user display screen, an input operation for specifying at least one of acceptance, rejection, and modification of the action plan candidate and the resource allocation candidate, and transmit the evaluation information or the selection information based on the input operation to the system via the communication network.

### Example 2

### (Supplementary 1)

A system comprising a processor,
wherein the processor is configured to
acquire, from an information storage unit that stores operation result information and user trend information for a predetermined past period, the operation result information and the user trend information by using a query language,
convert the acquired operation result information and user trend information into a time-series data structure by using a data processing program executed on a general-purpose arithmetic processing device, and perform numerical computation processing on the time-series data structure, the numerical computation processing including missing-value completion, aggregation processing, moving-average calculation, and seasonality analysis, generate visualization-structured data including indicator values and trend information for each time unit based on a result of the numerical computation processing, and output screen display information generated by a hypertext description language and a general-purpose script language by using the visualization-structured data,
generate a prompt sentence including explanatory information that summarizes past indicator values, trend information, and seasonality information based on the result of the numerical computation processing, and provide the prompt sentence and a feature vector extracted from the time-series data structure as input information to a generative artificial intelligence model, receive a natural language output and/or structured proposal information including a business policy plan from the generative artificial intelligence model, and generate integrated display information by associating the natural language output and/or the structured proposal information with the screen display information, and
transmit the integrated display information to an information display terminal via a communication network, and cause the information display terminal to display, in response to a user operation, a visualization result of the operation result information and the business policy plan in a mutually referable manner.

### (Supplementary 2)

The system according to supplementary 1,
wherein the processor is configured to
configure the prompt sentence to include a description sentence indicating a peak period, a low-activity period, a change in user visit frequency, and a past measure implementation timing identified by the numerical computation processing, and a request sentence that instructs the generative artificial intelligence model to generate presentation of a next-measure start timing, a duration, a resource allocation, and a risk factor, and to input the prompt sentence to the generative artificial intelligence model so as to cause the generative artificial intelligence model to generate prediction information and proposal information.

### (Supplementary 3)

The system according to supplementary 1,
wherein the processor is configured to
cause the information display terminal to present a graph display region and a proposal display region included in the integrated display information, receive input operations of period designation, indicator selection, condition change, and feedback information from a user via the information display terminal, and, in response to the input operations, re-execute data acquisition processing by the query language, the numerical computation processing, and generation and transmission processing of the prompt sentence to the generative artificial intelligence model.

### Application Example 2

### (Supplementary 1)

A system comprising a processor,
wherein the processor is configured to
extract, from a storage apparatus that stores records relating to past business performance for corresponding periods and visitor trends, associated information, and perform preprocessing on the information by using statistical techniques and machine learning techniques, the preprocessing including normalization and feature extraction,
construct a prediction model based on the preprocessed information, estimate future business indicators and visitor indicators by using the prediction model, and generate analysis results including the estimated indicators,
acquire user-related information including at least part of behavior history information, evaluation information, voice information, and image information of a user, estimate an emotional state of the user by using natural language processing techniques and emotion estimation techniques, and record the emotional state in association with the analysis results, dynamically construct a prompt sentence as an input statement for a generative AI model based on the analysis results and the emotional state, the prompt sentence including at least part of business performance information, visitor trend information, prediction result information, and emotional state information,
input the prompt sentence and the analysis results to the generative AI model, obtain advice information expressed in a natural language from the generative AI model, and analyze the advice information so as to format the advice information as structured advice data including at least part of an implementation timing, a resource allocation, a measure content, and a response policy,
generate visualization information based on the advice data and the analysis results, and transmit the visualization information and the advice data to a user display apparatus as input/output control,
acquire feedback information including at least part of evaluation information, acceptance information, and implementation result information regarding the advice data from the user display apparatus, and update the prediction model, the emotion estimation techniques, and configuration rules of the prompt sentence by using the feedback information as learning control, and
monitor, as real-time acquisition, transaction information and visitor measurement information, detect an outlier with respect to a past statistical distribution, and, when the outlier is detected, generate an additional prompt sentence reflecting the outlier and generate short-term tactical advice by using the generative AI model.

### (Supplementary 2)

The system according to supplementary 1,
wherein the processor is configured to
cause, as the input/output control, the user display apparatus to present the visualization information and the advice data in a dashboard format, and provide a user interface that accepts, from a user, at least one of a filtering operation based on a period, a location, and an item, and an instruction for regeneration of the advice.

### (Supplementary 3)

The system according to supplementary 1,
wherein the processor is configured to
evaluate, by the learning control, evaluation indices of the prediction model and configuration elements of the prompt sentence for the generative AI model by using the feedback information and business results associated with the advice data, and automatically adjust, based on an evaluation result, a description content, constraint conditions, and an output format of the prompt sentence.

What is claimed is:

1. A system comprising:
circuitry configured to:
receive, via a communication interface coupled to a packet-switched network, operational performance data and visitor trend information from a terminal device, and store the operational performance data and the visitor trend information in a storage device;
extract, from the storage device, the operational performance data and the visitor trend information for a corresponding past period, and analyze the extracted data using a statistical analysis technique to generate analysis result data;
perform preprocessing on the analysis result data comprising at least missing-value completion processing, outlier removal processing, and feature extraction processing, and normalize the preprocessed data to generate feature data;
apply a machine learning algorithm to the feature data to construct a prediction model that estimates future operational indicators and visitor indicators;
generate a prompt sentence based on the feature data and the analysis result data, input the prompt sentence to a generative neural network model, and obtain advice information generated by the generative neural network model; and
transmit the advice information and prediction results of the prediction model to the terminal device via the communication interface.

2. The system according to claim 1, wherein the circuitry is configured to acquire the operational performance data and the visitor trend information from an external information processing apparatus via the communication interface, and to store the operational performance data and the visitor trend information in a relational storage structure in the storage device.

3. The system according to claim 2, wherein the circuitry is configured to obtain the operational performance data and the visitor trend information from the storage device using a structured query mechanism, and to convert the obtained data into a time-series data structure prior to performing the statistical analysis technique.

4. The system according to claim 3, wherein the circuitry is configured to perform numerical computation processing on the time-series data structure comprising at least moving-average calculation and seasonality analysis, and to generate visualization-structured data comprising indicator values and trend information based on the numerical computation processing.

5. The system according to claim 4, wherein the circuitry is configured to generate the prompt sentence by incorporating the visualization-structured data, the indicator values, and the trend information as structured text input for the generative neural network model, and to obtain at least one of advice information, a prediction, or a proposal generated by the generative neural network model.

6. The system according to claim 1, wherein the circuitry is configured to perform preprocessing by executing attribute transformation processing and derived-attribute generation processing on the operational performance data and the visitor trend information to construct explanatory variables for the machine learning algorithm.

7. The system according to claim 6, wherein the circuitry is configured to construct the prediction model by training a regression or gradient boosting model on the explanatory variables, and to store analysis results comprising estimated operational indicators and visitor indicators in the storage device.

8. The system according to claim 7, wherein the circuitry is configured to update the prediction model by incorporating new operational performance data and visitor trend information received from the terminal device at periodic intervals, and to recompute the estimated indicators based on the updated prediction model.

9. The system according to claim 1, wherein the circuitry is configured to acquire event information and environment information from the storage device and to incorporate the event information and the environment information as additional context inputs when generating the prompt sentence for the generative neural network model.

10. The system according to claim 9, wherein the circuitry is configured to generate a second prompt sentence for instructing the generative neural network model to generate at least one of a prediction and a proposal based on the feature data, the event information, and the environment information, and to obtain the prediction and the proposal from the generative neural network model.

11. The system according to claim 1, wherein the circuitry is configured to acquire user-related information from the terminal device comprising at least one of behavior history information, evaluation information, or voice information, and to incorporate the user-related information into the prompt sentence to personalize the advice information generated by the generative neural network model.

12. The system according to claim 11, wherein the circuitry is configured to apply sentiment analysis or emotion identification processing to the voice information or text information received from the terminal device to estimate an emotional state of the user, and to adjust a tone and detail level of the advice information based on the estimated emotional state.

13. The system according to claim 1, wherein the circuitry is configured to provide an interface via the terminal device for displaying the prediction results and the advice information, and to receive feedback information from the user via the terminal device comprising at least one of an evaluation score or a correction with respect to the advice information.

14. The system according to claim 13, wherein the circuitry is configured to store the feedback information in the storage device and to incorporate the feedback information into a subsequent prompt sentence to refine advice information generated in subsequent processing cycles.

15. The system according to claim 14, wherein the circuitry is configured to update at least one of a prompt template or a feature extraction rule based on aggregated feedback information, and to re-execute feature extraction on newly received operational performance data using the updated feature extraction rule.

16. The system according to claim 1, wherein the circuitry is configured to generate a comparison prompt sentence that instructs the generative neural network model to compare current operational performance data with past period data, and to obtain comparative analysis information identifying deviations from a historical baseline.

17. The system according to claim 16, wherein the circuitry is configured to generate an alert notification based on the comparative analysis information when a deviation of an operational indicator exceeds a threshold, and to transmit the alert notification to the terminal device via the communication interface.

18. A system comprising:
circuitry configured to:
receive, via a communication interface coupled to a packet-switched network, operational performance data and visitor trend information from a terminal device, and store the data in a storage device;
extract the operational performance data and the visitor trend information from the storage device using a structured query mechanism, convert the data into a time-series data structure, and perform numerical computation processing comprising missing-value completion processing, moving-average calculation, and seasonality analysis;
perform preprocessing comprising outlier removal processing, attribute transformation processing, and feature extraction processing on the time-series data to generate feature data, and apply a machine learning algorithm to the feature data to construct a prediction model estimating future operational indicators and visitor indicators;
generate a prompt sentence incorporating the feature data, indicator values, and trend information, input the prompt sentence to a generative neural network model, and obtain at least one of advice information, a prediction, or a proposal; and
transmit the advice information, the prediction, and the prediction results of the prediction model to the terminal device via the communication interface.

19. The system according to claim 18, wherein the circuitry is configured to acquire user-related information from the terminal device comprising at least one of behavior history information or evaluation information, incorporate the user-related information into the prompt sentence, and receive feedback information from the terminal device to update a prompt template for use in subsequent processing cycles.

20. A method comprising:
receiving, via a communication interface coupled to a packet-switched network, operational performance data and visitor trend information from a terminal device, and storing the operational performance data and the visitor trend information in a storage device;
extracting, from the storage device, the operational performance data and the visitor trend information for a corresponding past period, and analyzing the extracted data using a statistical analysis technique to generate analysis result data;
performing preprocessing on the analysis result data comprising at least missing-value completion processing, outlier removal processing, and feature extraction processing, and normalizing the preprocessed data to generate feature data;
applying a machine learning algorithm to the feature data to construct a prediction model that estimates future operational indicators and visitor indicators;
generating a prompt sentence based on the feature data and the analysis result data, inputting the prompt sentence to a generative neural network model, and obtaining advice information generated by the generative neural network model; and
transmitting the advice information and prediction results of the prediction model to the terminal device via the communication interface.
